(19) United States
(12) Patent Application Publication
(10) Pub. No.: US 2014/0359356 A1
(43) Pub. Date: Dec. 4, 2014

(54) INFORMATION PROCESSING APPARATUS AND METHOD FOR SHUTTING DOWN VIRTUAL MACHINES

(71) Applicant: FUJITSU LIMITED, Kawasaki-shi (JP)

(72) Inventor: Shigeto AOKI, Fujisawa (JP)

(21) Appl. No.: 14/461,545

(22) Filed: Aug. 18, 2014

Related U.S. Application Data
(63) Continuation of application No. PCT/JP2012/058660, filed on Mar. 30, 2012.

(51) Int. Cl. G06F 11/14; G06F 11/30

(52) U.S. Cl. CPC G06F 11/1441; G06F 11/3062; G06F 2201/00
USPC 714/24

(57) ABSTRACT

A storage unit stores information indicating the priority level of each of a plurality of virtual machines. When causing the plurality of virtual machines to perform their shutdown processes in parallel, a control unit selects a first virtual machine from the plurality of virtual machines with reference to the storage unit. In addition, the control unit selects a second virtual machine from virtual machines with lower priority level than the first virtual machine with reference to the storage unit. The control unit then reduces the amount of resources allocated to the selected second virtual machine and increases the amount of resources allocated to the first virtual machine using resources equivalent to the reduced amount of resources.

### CROSS-REFERENCE TO RELATED APPLICATION

This application is a continuation application of International Application PCT/JP2012/058660 filed on Mar. 30, 2012 which designated the U.S., the entire contents of which are incorporated herein by reference.

### FIELD

The embodiments discussed herein relate to an information processing apparatus and a method for shutting down virtual machines.

### BACKGROUND

In the field of information processing, the virtualization technology is used to allow a plurality of virtual computers (may be called virtual machines or logical hosts) to run on physical computers (may be called physical machines or physical hosts). On each virtual machine, software, such as an Operating System (OS), etc., is able to run. A physical machine using the virtualization technology executes software for managing a plurality of virtual machines. For example, software called a hypervisor may allocate the processing power of a Central Processing Unit (CPU) or a storage space of a Random Access Memory (RAM) as computational resources to the plurality of virtual machines.

By the way, a physical machine is connected to a power source. A power outage or another failure may stop power supply from the power source to the physical machine. When an interruption occurs in the power supply to the physical machine, the physical machine suddenly shuts down. To deal with this problem, an Uninterruptible Power Supply (UPS) may be used in the power source of the physical machine. The UPS has a built-in rechargeable battery, and is connected to a commercial power source or the like. When a failure occurs in the power source, the UPS starts power supply from the battery, thereby preventing an interruption in the power supply to the physical machine during a power outage. There is also an idea of safely shutting down virtual machines and the physical machine with power supplied from the battery.

For example, there has been proposed a technique of, if a power source failure occurs in a virtualization server where a plurality of virtual machines runs, determining an order of shutting down the virtual machines by confirming the user-specified priority levels and the allocation of CPU resources with respect to the virtual machines, and shutting down the virtual machines.

There has also been proposed a technique of, if there are no sufficient resources available on any physical computer when migrating a virtual computer from a physical computer to another, selecting a physical computer where virtual computers with lower priority level than the virtual computer to be migrated run, removing as much resources as the virtual computer to be migrated actually used before the migration, from the virtual computers with lower priority level, and then allocating the removed resources to the virtual computer to be migrated.

Please see, for example, Japanese Laid-open Patent Publications Nos. 2009-282714 and 2011-128967.

At the time of an emergency due to a power outage or the like, a plurality of virtual machines running on an information processing apparatus may be shut down in parallel. Since resources are needed for shutting down each virtual machine, it would take a long time to shut down the virtual machines if sufficient resources may not be allocated to all the virtual machines. In addition, at the time of an emergency due to a power outage or the like, there may be a limited time to supply power to the physical machine. For example, if the battery in a UPS runs out, power is not supplied. Therefore, a problem arises in which the shutdown of the virtual machines may not be completed within the limited time.

For example, virtual machines may forcibly be shut down if the shutdown of the virtual machines is not completed in time. However, the forced shutdown would cause data inconsistency or another problem in the virtual machines. If this happens, a cost would be needed for solving this problem. The more significant process a virtual machine performs, the more serious the influence will be.

### SUMMARY

According to one aspect, there is provided an information processing apparatus on which a plurality of virtual machines is able to run. The information processing apparatus includes: a memory configured to store information indicating a priority level of each of the plurality of virtual machines; and a processor configured to perform a process including selecting, when causing the plurality of virtual machines to perform shutdown processes in parallel, a first virtual machine from the plurality of virtual machines with reference to the memory, selecting one or more second virtual machines from virtual machines with lower priority level than the first virtual machine with reference to the memory, reducing an amount of resources allocated to the selected one or more second virtual machines, and increasing an amount of resources allocated to the first virtual machine using resources equivalent to the reduced amount of resources.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWING

FIG. 1 illustrates an information processing apparatus according to a first embodiment;

FIG. 2 illustrates an information processing system according to a second embodiment;

FIG. 3 illustrates an example of a hardware configuration of an execution server according to the second embodiment;

FIG. 4 illustrates an example of a hardware configuration of a UPS according to the second embodiment;

FIG. 5 illustrates an example of an arrangement of virtual machines according to the second embodiment;

FIG. 6 illustrates exemplary software according to the second embodiment;

FIG. 7 illustrates an example of a power supply time table according to the second embodiment;

FIG. 8 illustrates a management table according to the second embodiment;

FIG. 9 illustrates an example of an initial resource value table according to the second embodiment;

FIG. 10 illustrates a minimum resource value table according to the second embodiment;

FIG. 11 illustrates a flowchart illustrating an exemplary process that is performed at the time of a power source failure according to the second embodiment;

FIG. 12 is a flowchart illustrating an example of a guest shutdown process according to the second embodiment;

FIG. 13 illustrates an example of transitions in the amount of allocated resources according to the second embodiment;

FIG. 14 is a sequence diagram for a power source failure according to the second embodiment;

FIG. 15 is another sequence diagram for a power source failure;

FIGS. 16A and 16B illustrate examples of the time taken for a shutdown process with different amounts of allocated resources;

FIG. 17 illustrates an allocated resource threshold table according to a third embodiment.

FIG. 18 is a flowchart illustrating an example of a guest shutdown process according to the third embodiment; and

FIG. 19 illustrates an example of transitions in the amount of allocated resources according to the third embodiment.

### DESCRIPTION OF EMBODIMENTS

Several embodiments will be described below with reference to the accompanying drawings, wherein like reference numerals refer to like elements throughout.

### First Embodiment

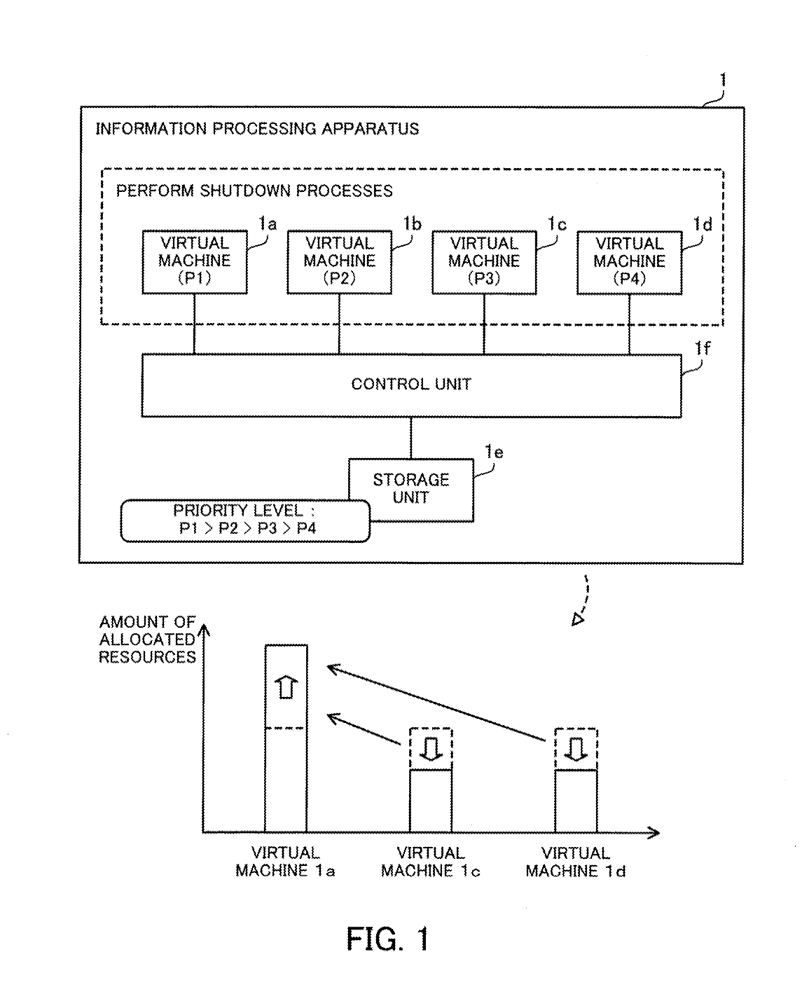

FIG. 1 illustrates an information processing apparatus according to a first embodiment. An information processing apparatus 1 includes virtual machines 1a, 1b, 1c, and 1d, a storage unit 1e, and a control unit 1f. The information processing apparatus 1 may be provided with a processor, such as a CPU, etc. and a memory, such as a RAM, etc. or may be a computer in which a processor executes a program stored in a memory.

The virtual machines 1a, 1b, 1c, and 1d are virtual computers that run on the information processing apparatus 1. For example, a hypervisor executed by the information processing apparatus 1 may run the virtual machines 1a, 1b, 1c, and 1d on the information processing apparatus 1.

The storage unit 1e stores information indicating the priority levels of the respective virtual machines 1a, 1b, 1c, and 1d. For example, the virtual machines 1a, 1b, 1c, and 1d have priority levels of “P1”, “P2”, “P3”, and “P4”, respectively. In the example of FIG. 1, the priority level of “P1” is the highest. Then, the priority level of “P2” is the next highest, and then the priority level of “P3” is the next highest, and the priority level of “P4” is the lowest. In FIG. 1, this priority order is represented as “P1>P2>P3>P4”.

When causing the virtual machines 1a, 1b, 1c, and 1d to perform their shutdown processes in parallel, the control unit 1f selects a first virtual machine with reference to the storage unit 1e. In addition, the control unit 1f selects one or more second virtual machines with lower priority level than the first virtual machine with reference to the storage unit 1e.

For example, when a failure in a power source that supplies power to the information processing apparatus 1 is detected, the control unit 1f causes the virtual machines 1a, 1b, 1c, and 1d to perform their shutdown processes in parallel. This is an attempt to shut down the virtual machines 1a, 1b, 1c, and 1d as safe as possible before the power supply to the information processing apparatus 1 ceases.

For example, a power source device connected to the information processing apparatus 1 may detect a failure in the power source by detecting a power source abnormality. When detecting the power source abnormality, the power source device may notify the information processing apparatus 1 of this abnormality. If there is another device that manages the information processing apparatus 1, the power source device may notify the information processing apparatus 1 of the power source abnormality via the other device. When receiving the notification of the power source abnormality, the control unit 1f may instruct the virtual machines 1a, 1b, 1c, and 1d to shut down.

For example, the control unit 1f selects the virtual machine 1a with the highest priority level as a first virtual machine from the virtual machines 1a, 1b, 1c, and 1d. Then, for example, the control unit 1f selects one or more second virtual machines in order from the lowest priority level from the virtual machines 1b, 1c, and 1d with lower priority level than the priority level of “P1” of the virtual machine 1a. For example, in the case of selecting two second virtual machines, the control unit 1f selects two virtual machines 1c and 1d with low priority level as the second virtual machines. In this connection, all of the virtual machines 1b, 1c, and 1d with lower priority level than the virtual machine 1a may be selected as second virtual machines.

The control unit 1f reduces the amount of resources allocated to the selected second virtual machines and increases the amount of resources allocated to the first virtual machine using the reduced amount of resources. For example, in the case where the virtual machine 1a is selected as the first virtual machine and the virtual machines 1c and 1d are selected as the second virtual machines, the control unit 1f reduces the amount of resources allocated to the virtual machines 1c and 1d, and then increases the amount of resources allocated to the virtual machine 1a using resources equivalent to the amount of resources reduced from the virtual machines 1c and 1d.

There are two methods for increasing the amount of resources allocated to the virtual machine 1a using resources equivalent to the reduced amount of resources. The first method is to allocate the virtual machine 1a resources removed from the virtual machines 1c and 1d as they are. The second method is to extract resources equivalent to the amount of resources reduced from the virtual machines 1c and 1d from all free resources and allocate them (resource redistribution). With one of these methods, the control unit 1f increases the amount of resources allocated to the virtual machine 1a.

In addition, the control unit 1f may change the resource allocation as described above, either before or after instructing the virtual machines 1a, 1b, 1c, and 1d to shut down.

In this information processing apparatus 1, when the control unit 1f causes the virtual machines 1a, 1b, 1c, and 1d to perform their shutdown processes in parallel, the control unit 1f refers to the storage unit 1e to select a first virtual machine from the virtual machines 1a, 1b, 1c, and 1d and then to select one or more second virtual machines from virtual machines with lower priority level than the first virtual machine. The control unit 1f then reduces the amount of resources allocated to the selected second virtual machines and increases the amount of resources allocated to the first virtual machine using resources equivalent to the reduced amount of resources.

This technique speeds up the shutdown process of a virtual machine with high priority level. More specifically, an increase in the amount of resources allocated to a virtual machine allows the virtual machine to use more CPU processing power and more RAM storage space. This leads to speeding up the shutdown process, as compared with the case where the amount of allocated resources is not increased. That is to say, an increase in the amount of resources allocated to a virtual machine makes it possible to reduce the time to complete the shutdown process of the virtual machine.

When a power source failure occurs, there may be a limited time to supply power to the information processing apparatus 1 (because power is supplied from a battery of a UPS, or another reason). If there are free resources, which are not allocated to any resources, it would be possible to allocate these free resources to virtual machines to reduce the time to complete their shutdown processes. However, such free resources might be insufficient for the virtual machines to shut down safely within the limited time. Further, there may be no free resources.

To deal with this matter, the information processing apparatus 1 deallocates resources from the second virtual machines with lower priority level than the first virtual machine, and collectively allocates the deallocated resources to the first virtual machine. For example, a virtual machine that performs a more significant process may be given a higher priority level for shutdown. In addition, a virtual machine that is desired to shut down safely may be given a high priority level. This allows such a virtual machine to further reduce the time to complete the shutdown process. For example, even if there is a limited time to supply power, it is possible to increase the possibility that the virtual machine with high priority level completes its shutdown safely within the limited time.

After the deallocated resources are allocated to the first virtual machine, the virtual machines 1a, 1b, 1d, and 1d complete their shutdown processes. At this time, the control unit 1f may deallocate resources from a virtual machine that has completed its shutdown, and may additionally allocate the deallocated resources to any of virtual machines performing their shutdown processes. For example, the deallocated resources may additionally be allocated to a virtual machine with the highest priority level among the virtual machines performing their shutdown processes. This reduces the time to complete the shutdown of the virtual machine with relatively high priority level among the running virtual machines. Thereby, it is possible to increase the possibility that the virtual machine completes its shutdown safely within the limited time.

In this connection, for example, the functions of the control unit 1f may be provided in a virtual machine for controlling the virtual machines 1a, 1b, 1c, and 1d or in a hypervisor.

### Second Embodiment

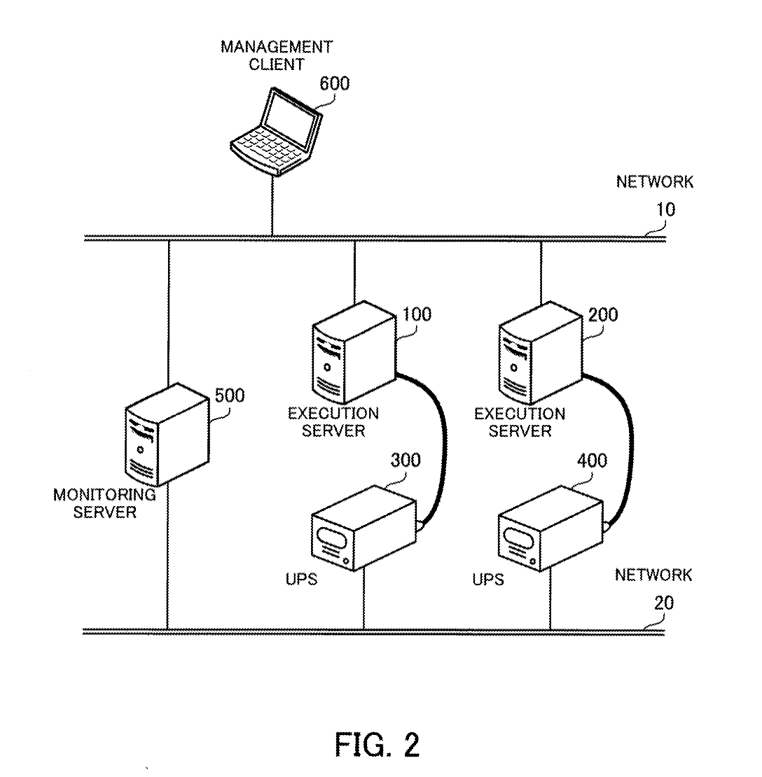

FIG. 2 illustrates an information processing system according to a second embodiment. The information processing system of the second embodiment includes execution servers 100 and 200, UPSs 300 and 400, a monitoring server 500, and a management client 600. The execution servers 100 and 200, the monitoring server 500, and the management client 600 are connected to a network 10. The network 10 is, for example, a Local Area Network (LAN). The UPSs 300 and 400 and the monitoring server 500 are connected to a network 20. The network 20 is a LAN for, for example, monitoring the UPSs 300 and 400 and others.

The execution servers 100 and 200 are server computers on which a plurality of virtual machines is able to run. The virtual machines running on the execution servers 100 and 200 work in collaboration with each other to provide prescribed service for client computers (not illustrated) connected to the network 10 or to a network (not illustrated) outside the network 10.

Each of the UPSs 300 and 400 is an uninterruptible power supply device with a built-in battery. The UPS 300 is connected to the execution server 100 with a power supply cable and supplies power to the execution server 100. The UPS 400 is connected to the execution server 200 with a power supply cable and supplies power to the execution server 200. In this connection, an UPS, not illustrated, may be connected to the monitoring server 500 in case of a power outage or another power source failure.

The monitoring server 500 is a server computer that monitors the operational states of other devices. The UPSs are also monitored by the monitoring server 500. For example, the monitoring server 500 receives a notification indicating that a power source abnormality has been detected, from a UPS 300 and 400, and then notifies the corresponding execution server 100 and 200 that the power source failure has occurred.

The management client 600 is a client computer that is operated by an administrator of the information processing system of the second embodiment. With the management client 600, the administrator is able to confirm the monitoring result obtained by the monitoring server 500, and is also able to instruct the execution servers 100 and 200 to shut down.

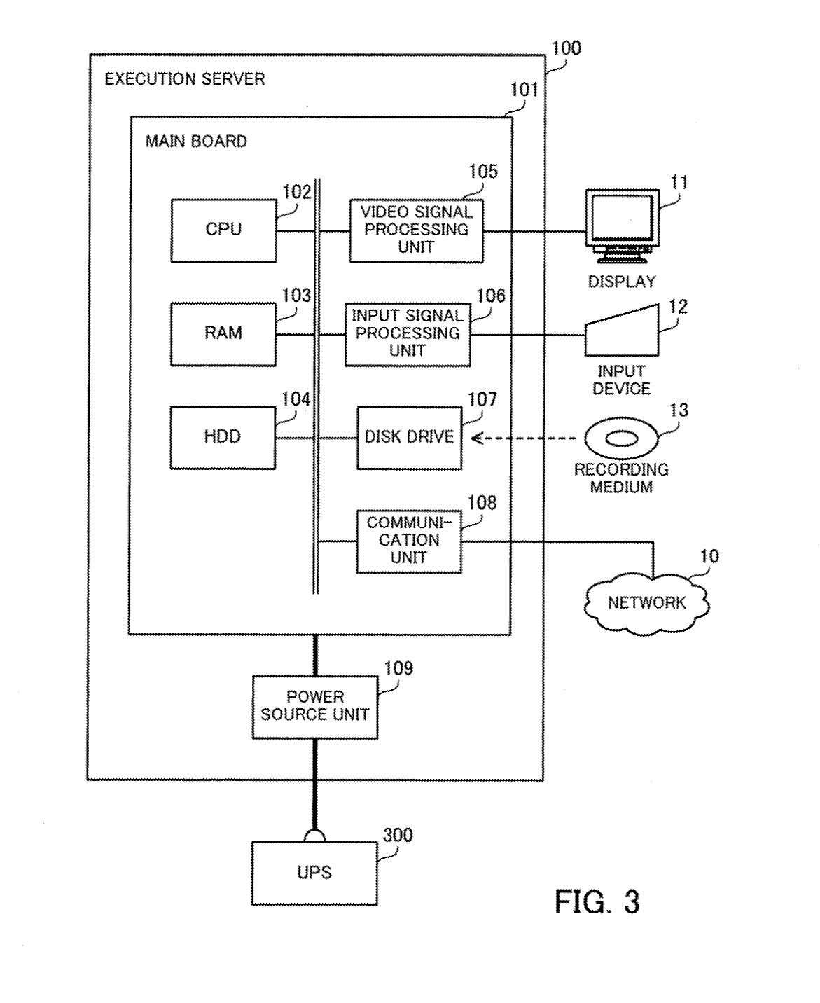

FIG. 3 illustrates an example of a hardware configuration of an execution server according to the second embodiment. The execution server 100 includes a main board 101, a CPU 102, a RAM 103, a Hard Disk Drive (HDD) 104, a video signal processing unit 105, an input signal processing unit 106, a disk drive 107, a communication unit 108, and a power source unit 109. The execution server 200, the monitoring server 500, and the management client 600 may have the same hardware configuration as the execution server 100.

The main board 101 is a substrate on which other units of the execution server 100 are connected to each other. The main board 101 supplies power from the power source unit 109 to the other units of the execution server 100.

The CPU 102 is a processor that controls information processing performed by the execution server 100. The CPU 102 loads at least part of programs and data from the HDD 104 to the RAM 103 and runs the programs. The execution server 100 may be provided with a plurality of processors to execute programs in a distributed manner.

The RAM 103 is a volatile memory that temporarily stores programs to be run by the CPU 102 and data to be used in processing. In this connection, the execution server 100 may be provided with a different type of memory from RAM or with a plurality of memories.

The HDD 104 is a non-volatile memory that stores programs, such as OS programs, application programs, etc., and data. The HDD 104 magnetically writes and reads data on a built-in magnetic disk in accordance with commands from the CPU 102. In this connection, the execution server 100 may be provided with a different type of non-volatile memory device (for example, a Solid State Drive (SSD), etc.) from HDD or with a plurality of memory devices.

The video signal processing unit 105 outputs images to a display 11 connected to the execution server 100 in accordance with commands from the CPU 102. As the display 11, a Cathode Ray Tube (CRT) display or a liquid crystal display may be used, for example.

The input signal processing unit 106 receives an input signal from an input device 12 connected to the execution server 100 and outputs the input signal to the CPU 102. As the input device 12, for example, a pointing device, such as a mouse, a touch panel, etc., a keyboard, or another may be used.

The disk drive 107 is a driving device that reads programs and data from a recording medium 13. As the recording medium 13, for example, a magnetic recording device, an optical disc, a magneto-optical recording medium, or a semiconductor memory may be used. The magnetic recording device may be an HOD, a Flexible Disk (FD), magnetic tape, or another. The optical disc may be a Compact Disc (CD), a CD-R (Recordable), a CD-RW (ReWritable), a Digital Versatile Disc (DVD), a DVD-R, a DVD-RW, a DVD-RAM, or another. The magneto-optical recording medium may be a Magneto-Optical Disk (MO) or another. The semiconductor memory may be a flash memory, such as a Universal Serial Bus (USB), etc. For example, the disk drive 107 stores programs and data read from the recording medium 13 in the RAM 103 or the HDD 104 in accordance with commands from the CPU 102.

The communication unit 108 is a communication interface for communication with another server over the network 10. The communication unit 108 may be a wired communication interface or a wireless communication interface.

The power source unit 109 is connected to the UPS 300 with a power supply cable, and supplies power from the UPS 300 to the main board 101.

In this connection, the monitoring server 500 also includes a communication unit for connection to the network 20.

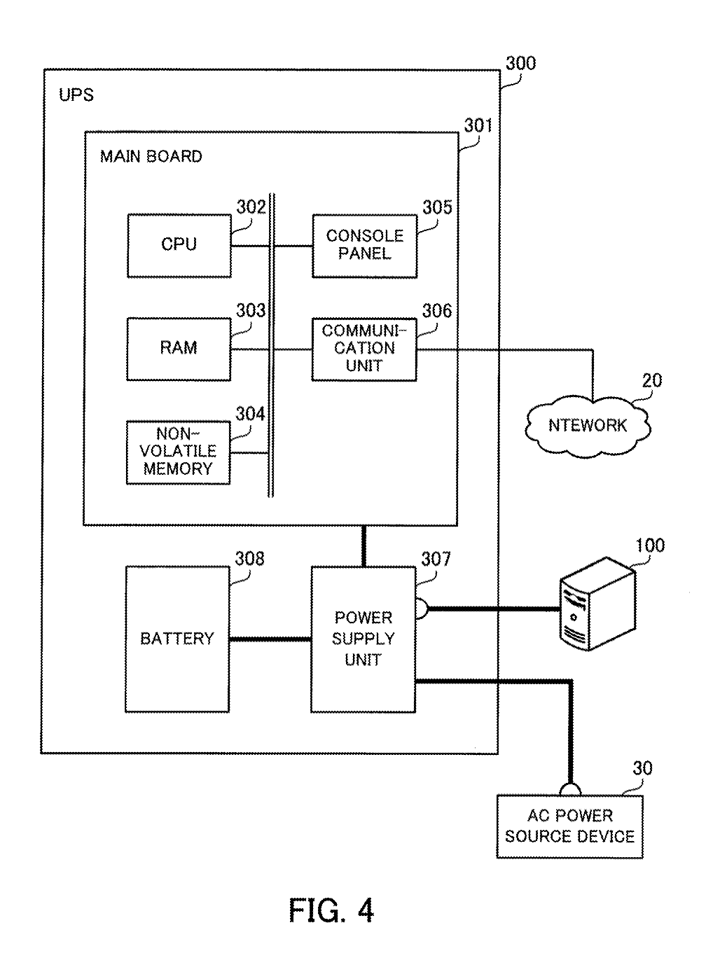

FIG. 4 illustrates an example of a hardware configuration of a UPS according to the second embodiment. The UPS 300 includes a main board 301, a CPU 302, a RAM 303, a non-volatile memory 304, a console panel 305, a communication unit 306, a power supply unit 307, and a battery 308. The UPS 400 may nave the same hardware configuration as the UPS 300.

The main board 301 is a substrate on which units other than the battery 308 of the UPS 300 are connected to each other. The main board 301 also supplies power from the power supply unit 307 to the units other than the battery 308 of the UPS 300.

The CPU 302 is a processor that controls information processing performed by the UPS 300. The CPU 302 loads at least part of programs and data from the non-volatile memory 304 to the RAM 303 and runs the programs.

The RAM 303 is a volatile memory that temporarily stores programs to be run by the CPU 302 and data to be used in processing.

The non-volatile memory 304 is a non-volatile storage device that stores programs, such as firmware programs, etc., and data. The non-volatile memory 304 is, for example, a semiconductor memory.

The console panel 305 is an interface provided with an input section for the administrator to enter operational commands to the UPS 300 and a display section for the administrator to confirm the state of the UPS 300.

The communication unit 306 is a communication interface for communication with the monitoring server 500 over the network 20. In communication, the communication unit 306 may be connected directly or indirectly to the monitoring server 500 with a serial transmission cable, such as a Recommended Standard 232 version C (RS-232C) cable, an Inter-Integrated Circuit (I2C) cable, a USB cable, etc.

The power supply unit 307 is connected to an Alternating Current (AC) power source device 30 with a power supply cable. The AC power source device 30 here may be a device that supplies commercial power, a device that supplies self-generated power, or another. The power supply unit 307 charges the battery 308 with power supplied from the AC power source device 30. In normal time, while charging the battery 308, the power supply unit 307 supplies power from the AC power source device 30 to the execution server 100 and the main board 301.

When detecting a power outage (interruption of power supply from the AC power source device 30) or another power source abnormality, the power supply unit 307 starts power supply from the battery 308 immediately. In this case, the power supply unit 307 supplies power from the battery 308 to the execution server 100 and the main board 301.

The battery 308 is rechargeable. As the battery 308, a lead battery may be used.

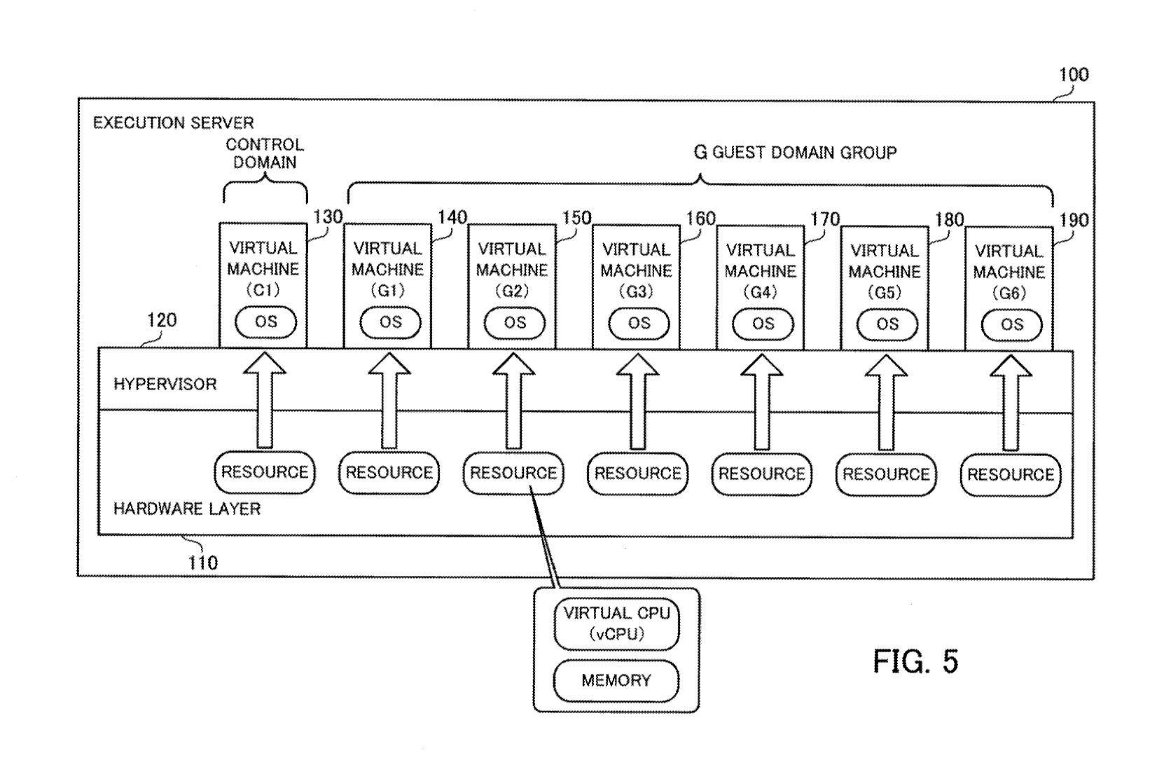

FIG. 5 illustrates an example of an arrangement of virtual machines according to the second embodiment. The execution server 100 includes a hardware layer 110, a hypervisor 120, and virtual machines 130, 140, 150, 160, 170, 180, and 190.

The hardware layer 110 is a set of physical resources including the main board 101, CPU 102, RAM 103, HDD 105, input signal processing unit 106, disk drive 107, and communication unit 108.

The hypervisor 120 operates the virtual machines using the resources of the hardware layer 110. The hypervisor 120 allocates each virtual machine the processing power of the CPU 102 and the memory space of the PRAM 103 as computational resources. The hypervisor 120 arbitrates access from the virtual machines to the hardware layer 110 so that the virtual machines are able to share the resources of the hardware layer 110. The hypervisor 120 may be called a Virtual Machine Monitor (VMM).

The smallest portion of the processing power of the CPU 102 that the hypervisor 120 allocates to each virtual machine may be called a virtual CPU. For example, one virtual CPU may correspond to one of time slices into which a time period during which the CPU 102 is available is divided. For example, one virtual CPU indicates one time slice of the CPU 102. One virtual CPU may correspond to a plurality of time slices. The amount of allocated virtual CPUs is expressed by the number of virtual CPUs. In this connection, a virtual CPU may be called a vCPU hereinafter.

In addition, a storage space of the RAM 103 that the hypervisor 120 allocates to each virtual machine may simply be called memory. The amount of allocated memory is expressed by the size of a storage space, such as Giga Bytes (GB).

The virtual machines 130, 140, 150, 160, 170, 180, and 190 run on the execution server 100. Each of the virtual machines executes an OS independently of each other. The same OS or different OSs may be executed by the virtual machines.

A run unit for a virtual machine on the execution server 100 may be called a domain.

Especially, the virtual machine 130 manages the other virtual machines. For example, the virtual machine 130 manages the amount of resources allocated to the other virtual machines. Such a virtual machine may be called a control, domain. The control domain (virtual machine 130) is automatically executed when, for example, the hypervisor 120 starts.

In addition, the virtual machines 140, 150, 160, 170, 180, and 190 other than the control domain (virtual machine 130) may be called guest domains. In the following explanation, the virtual machines 140, 150, 160, 170, 180, and 190 may collectively be called a guest domain group G. Each of the virtual machines 140, 150, 160, 170, 180, and 190 may be called a guest domain. A guest domain may be abbreviated to a guest. After the control domain is started, a plurality of guest domains may be started on the execution server 100 in accordance with an instruction from an administrator or the like.

Each virtual machine is given the following machine name. The virtual machine 130 is given “C1”. The virtual machines 140, 150, 160, 170, 180, and 190 are given “G1”, “G2”, “G3”, “G4”, “G5”, and “G6”, respectively.

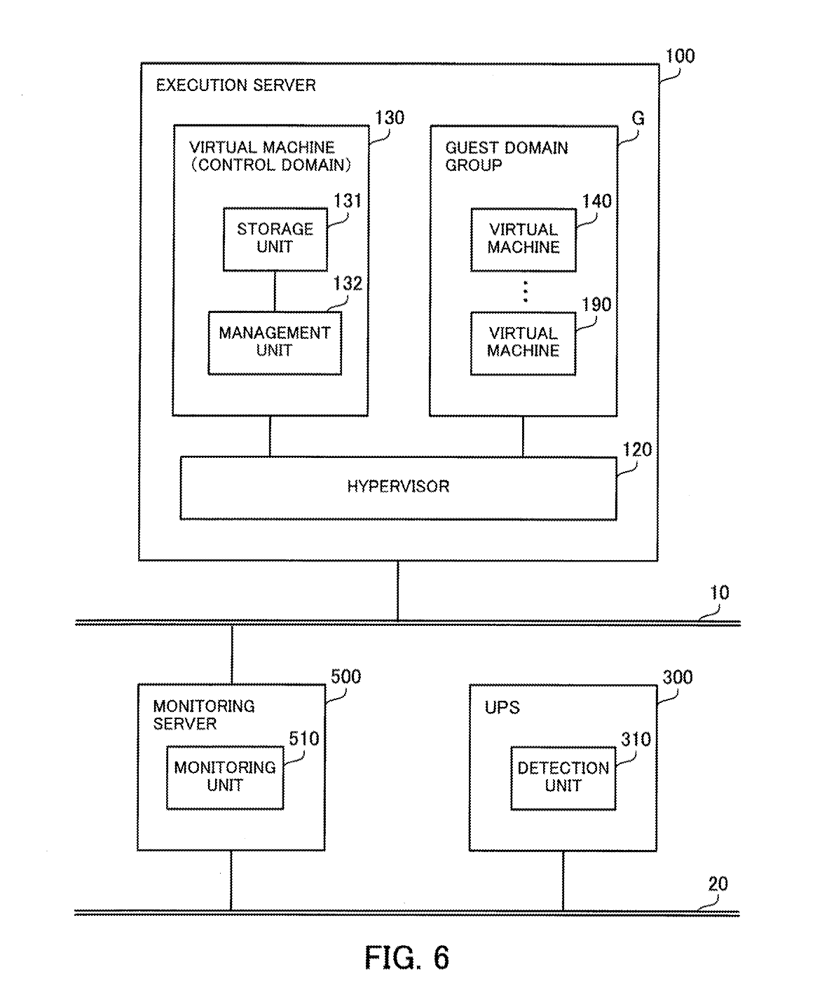

FIG. 6 illustrates exemplary software according to the second embodiment. Some or all of a management unit 132, a detection unit 310, and a monitoring unit 510 illustrated in FIG. 6 may be implemented as program modules to be executed by the execution server 100, the UPS 300, and the monitoring server 500, or as a Field Programmable Gate Array (FPGA), Application Specific Integrated Circuit (ASIC), or other electronic circuits. In this connection, the execution server 200 and the UPS 400 are not illustrated in FIG. 6. The execution server 200 may be configured using the same units as the execution server 100. The UPS 400 may be configured using the same units as the UPS 300. A power supply cable that connects the execution server 100 and the UPS 300 is not illustrated in FIG. 6.

The virtual machine 130 includes a storage unit 131 and the management unit 132.

The storage unit 131 stores various types of data to be used in processing performed by the management unit 132. Data stored in the storage unit 131 include a power supply time table, a management table, an initial resource value table, and a minimum resource value table. The power supply time table is used for managing a time period during which the UPS 300 is able to supply power from a battery. The management table is used for managing information on guest domains. The initial resource value table is used for managing initial values for the amount of resources allocated to each guest domain for performing a shutdown process. The minimum resource value table is used for managing the minimum amount of resources allocated to each guest domain.

When receiving a notification of power source failure from the monitoring server 500, the management unit 132 instructs the guest domain group G to shut down. More specifically, the management unit 132 causes the OS running on each of the virtual machines 140, 150, 160, 170, 180, and 190 to start shutting down. The management unit 132 gives such an instruction to the guest domain group G via the hypervisor 120. In addition, the management unit 132 changes the amount of resources allocated to each of the virtual machines 130, 140, 150, 160, 170, 180, and 190 on the basis of the data stored in the storage unit 131. After all of the guest domains shut down, the management unit 132 shuts down the virtual machine 130. When all of the virtual machines are shut down by the management unit 132, the hypervisor 120 shuts down the execution server 100.

In this connection, the storage unit 131 and the management unit 132 may be provided in the hypervisor 120.

The UPS 300 includes the detection unit 310 that detects a power outage. When detecting a power outage from the power supply unit 307, the detection unit 310 notifies the monitoring unit 510 of the power source abnormality. The detection unit 310 includes information indicating a power supply time based on the charged amount of the battery 308 in the notification.

The monitoring server 500 includes the monitoring unit 510 that holds a correspondence between the execution server 100 and the UPS 300 and a correspondence between the execution server 200 and the UPS 400. When receiving a notification of power source abnormality from the detection unit. 310, the monitoring unit 510 notifies the execution server 100 corresponding to the UPS 300 of the occurrence of the power source failure (notification of power source failure). The monitoring unit 510 includes information indicating a power supply time based on the charged amount of the battery 308 in the notification. Either the detection unit 310 or the monitoring unit 510 may be designed to include the time when the power source abnormality or the power source failure was detected, in the notification.

In this connection, the monitoring unit 510 may be provided in the execution server 100. For example, the CPU 102 may function as the monitoring unit 510 by executing a predetermined program. Alternatively, for example, a SerVice Processor (SVP) board may be provided in the execution server 100 so as to cause the SVP board to function as the monitoring unit 510. In the case where the monitoring unit 510 is provided in the execution server 100, for example, the execution server 100 and the UPS 300 may be connected directly or indirectly with a serial transmission cable, a LAN cable, or another cable to enable communication with each other. In addition, the execution server 100 may be connected to the network 20 as well in order to enable communication between the execution server 100 and the UPS 300.

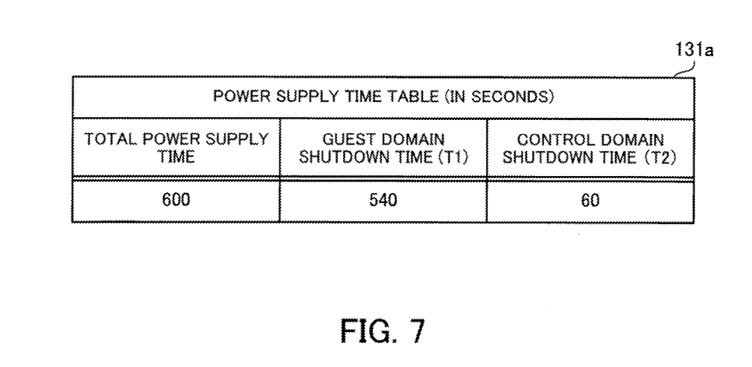

FIG. 7 illustrates an example of a power supply time table according to the second embodiment. A power supply time table 131a is stored in the storage unit 131. The power supply time table 131a includes the following fields: total power supply time, guest domain shutdown time (T1), and control domain shutdown time (T2). A time to be set in each field is expressed in, for example, seconds.

The total power supply time field indicates how much time the battery 308 is able to supply power (power supply time). The guest domain shutdown time (T1) field indicates how much time to spend on shutting down the guest domains after the power supply from the battery 308 starts, out of the power supply time. The control domain shutdown time (T2) field indicates how much time to spend on shutting down the virtual machine 130 serving as a control domain after all the guest domains shut down.

For example, the power supply time table 131a include a record with a total power supply time of “600” (seconds), a guest domain shutdown time (T1) of “540” (seconds), and a control domain shutdown time (T2) of “60” (seconds). This record indicates that, out of the total power supply time of 600 seconds, during which power supply from the battery 308 is available, the first 540 seconds are spent on shutting down the guest domains and the remaining 60 seconds are spent on shutting down the virtual machine 130 serving as a control domain.

In this connection, the control domain shutdown time (T2) includes a time for shutting down the hypervisor 120 together with the virtual machine 130 and then shutting down the execution server 100. However, the time for shutting down the hypervisor 120 and the execution server 100 may be set separately from T2.

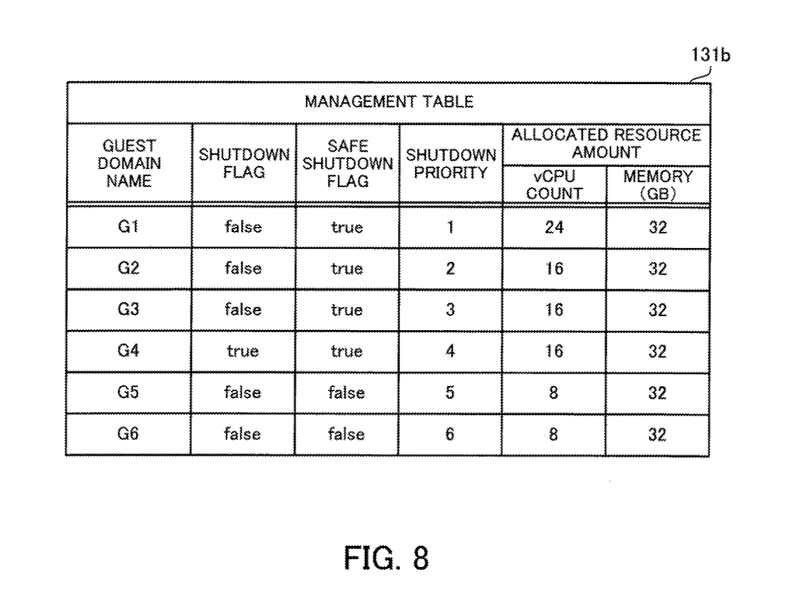

FIG. 8 illustrates a management table according to the second embodiment. A management table 131b is stored in the storage unit 131. The management table 131b includes the following fields: guest domain name, shutdown flag, safe shutdown flag, shutdown priority, and allocated resource amount.

The guest domain name field contains the machine name of a guest domain. The shutdown flag field contains a flag indicating whether the guest domain has shut down or not. A flag of “true” indicates that the guest domain has shut down, and a flag of “false” indicates that the guest domain is running. The safe shutdown flag field contains a flag indicating whether the guest domain is a candidate for safe shutdown or not. A flag of “true” indicates that the guest domain is a candidate for safe shutdown, and a flag of “false” indicates that the guest domain is not a candidate for safe shutdown. “Safe shutdown (shut down safely)” means that the shutdown process of the guest domain needs to be completed without interruption. “Not shut down safely” means that the guest domain needs to be shut down forcibly even if it is in the middle of the shutdown process. That is to say, a guest domain that is a candidate for safe shutdown is a virtual machine that needs to be shut down safely. A guest domain that is not a candidate for safe shutdown is a virtual machine that may not be shut down safely. The shutdown priority field contains a priority level for shutting down the guest domain. A priority level is determined according to the significance of functions and processing that a guest domain performs and whether the quest domain is a candidate for safe shutdown or not. In this example, the priority level is expressed by a numerical value, by way of example, and a smaller value indicates a higher priority level. The allocated resource amount field indicates the current amount of resources allocated to the guest domain. The allocated resource amount field further has the following subfields: vCPU count and memory (GB). The vCPU count field indicates the number of vCPUs allocated to the guest domain. The memory (GB) field contains the size of memory allocated to the guest domain.

For example, the management table 131b includes a record with a guest domain name of “G1”, a shutdown flag of “false”, a safe shutdown flag of “true”, a shutdown priority of “1”, a vCPU count of “24”, and a memory (GB) of “32”. This record indicates that the virtual machine 140 (guest domain name “G1”) is running, is a candidate for safe shutdown, and has a shutdown priority level of “1”, meaning the highest priority level among the guest domain group G. The record also indicates that the virtual machine 140 is currently allocated 24 vCPUs and 32 GB of memory as computational resources.

Further, for example, referring to the management table 131b, the virtual machine 170 (guest domain name “G4”) has a shutdown flag of “true”. This means that the virtual machine 170 has shut down (not running).

Still further, for example, referring to the management table 131b, the virtual machine 180 (guest domain name “G5”) has a safe shutdown flag of “false”. This means that the virtual machine 180 is not a candidate for safe shutdown. The virtual machine 190 is not a candidate for safe shutdown as well.

In this connection, as described earlier, a priority level is previously registered by an administrator or the like according to the significance of a guest domain. For example, consider the case where guest domains function as a Web server, an APplication (AP) server, and a Database (DB) server, respectively, and provide prescribed service in collaboration with each other, and it may be defined that the DB server for managing user data is of the most significance and then the AP server is of the next most significance, and then the Web server is of the least significance. In this case, the priority level of each guest domain is defined such that a higher priority level is given to a more significant server. For example, the guest domain functioning as the DB server is given the highest priority level, the guest domain functioning as the AP server is given the next highest priority level, and the guest domain functioning as the Web server is given the lowest priority level. Alternatively, the significance of each guest domain may be defined according to the significance of the business process that the guest domain performs, and a priority level according to the defined significance may be registered in the management table 131b. Further, guest domains that are candidates for safe shutdown are given higher priority levels than guest domains that are not candidates for safe shutdown.

In addition, predetermined values (for example, a vCPU count of 16 and a memory of 32G) are set as the amount of allocated resources for the virtual machine 130 serving as a control domain.

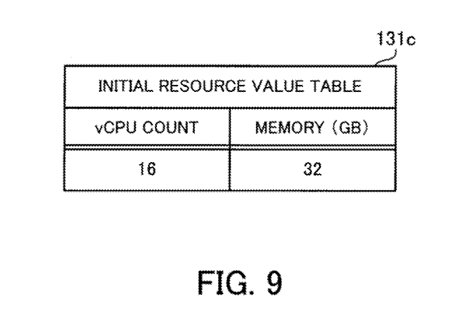

FIG. 9 illustrates an example of an initial resource value table according to the second embodiment. An initial resource value table 131c is stored in the storage unit 131. The initial resource value table 131c includes the following fields: vCPU count and memory (GB).

The vCPU count field contains an initial value indicating the number of vCPUs to be allocated to each guest domain at the time of performing a shutdown process. The memory (GB) field contains an initial value indicating the size of memory to be allocated to each guest domain at the time of performing the shutdown process. For example, the initial value for the number of vCPUs is 16, and the initial value for the size of memory is 32 GB. An appropriate initial value for operation may be set for each resource type.

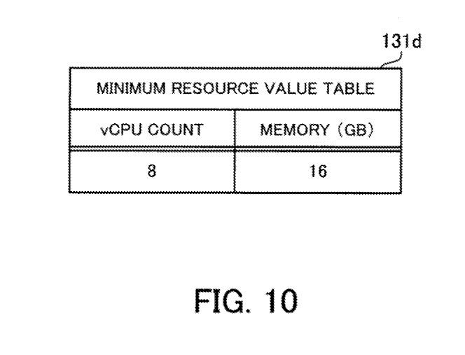

FIG. 10 illustrates a minimum resource value table according to the second embodiment. A minimum resource value table 131d is stored in the storage unit 131. The minimum resource value table 131d includes the following fields: vCPU count and memory (GB).

The vCPU count field contains a minimum value for the number of vCPUs to be allocated to each guest domain. The memory (GB) field contains a minimum value for the size of memory to be allocated to each guest domain. For example, the minimum value for the number of vCPUs is 8 and the minimum value for the size of memory is 16 GB. An appropriate minimum value for operation may be set for each resource type.

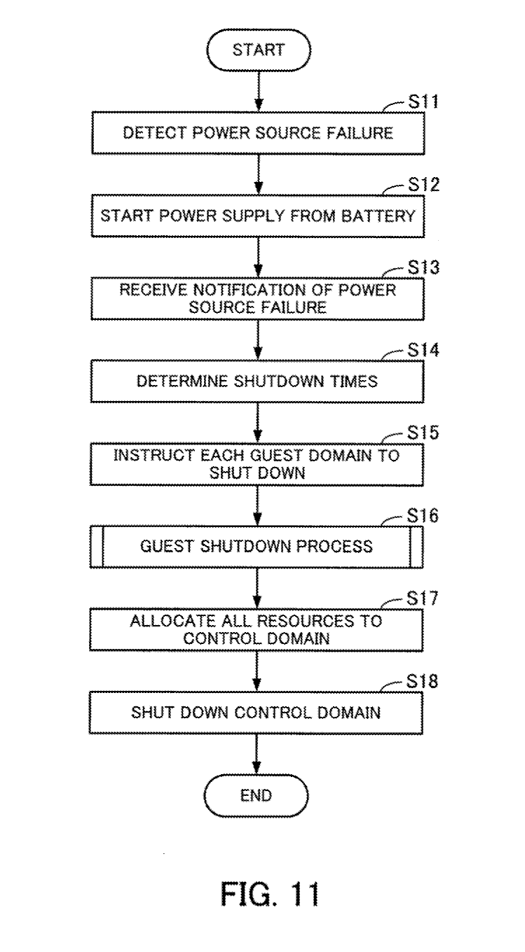

FIG. 11 illustrates a flowchart illustrating an exemplary process that is performed at the time of a power source failure according to the second embodiment. The process illustrated in FIG. 11 will be described step by step.

(Step S11) A failure occurs in the AC power source device 30, and the output power decreases accordingly. The power supply unit 307 detects that the power supply from the AC power source device 30 has stopped (or that a predetermined amount of power has not been supplied).

(Step S12) The power supply unit 307 starts power supply from the battery 308. When the power supply from the battery 308 starts, the detection unit 310 sends a notification of the power source abnormality to the monitoring unit 510. This notification includes a power supply time based on the charged amount of the battery 308. For example, the power supply time of the fully charged battery 308 is about 600 seconds.

(Step S13) When receiving the notification of power source abnormality, the monitoring unit 510 sends a notification of power source failure to the execution server 100 corresponding to the UPS 300. The notification of power source failure includes a power supply time. The power supply time included in the notification of power source failure is the same as the power supply time included in the notification of power source abnormality. The management unit 132 receives the notification of power source failure from the monitoring unit 510.

(Step S14) The management unit 132 determines a guest domain shutdown time (T1) and a control domain shutdown time (T2) on the basis of the power supply time indicated in the notification of power source failure, and registers the determined times in the power supply time table 131a stored in the storage unit 131. The management unit 132 registers the power supply time in the total power supply time field of the power supply time table 131a. A ratio of the guest domain shutdown time (T1) to the control domain shutdown time (T2) in the power supply time is previously given to the management unit 132. For example, T1:T2=9:1 is specified. In the case where the power supply time is 600 seconds, the management unit 132 calculates the times T1 and T2 as T1=540 seconds and T2=60 seconds. Accordingly, the management unit 132 registers “540” and “60” in the guest domain shutdown time (T1) field and the control domain shutdown time (T2) field, respectively. The management unit 132 starts to count the time.

(Step S15) The management unit 132 instructs the hypervisor 120 to shut down all the virtual machines 140, 150, 160, 170, 180, and 190 (each guest domain) included in the guest domain group G. The hypervisor 120 causes each guest domain to start shutting down. If there is a guest domain that has already shut down (for example, virtual machine 170), the management unit 132 may not issue an instruction for shutting down the guest domain.

(Step S16) Each guest domain performs its shutdown process. While the shutdown processes are performed, the management unit 132 changes the amount of resources allocated to each guest domain. For example, the management unit 132 is designed to instruct the hypervisor 120 how to change the amount of resources allocated to each guest domain.

(Step S17) When all the guest domains complete their shutdown, the management unit 132 allocates all free resources to the virtual machine 130 serving as a control domain.

(Step S18) The management unit 132 shuts down the virtual machine 130. When the virtual machine 130 shuts down, the hypervisor 120 also shuts down, thereby completing the shutdown of the execution server 100.

As described above, when receiving a notification of power source failure from the monitoring unit 510, the management unit 132 first shuts down the guest domains. Then, the management unit 132 allocates the virtual machine 130 serving as a control domain all of the resources allocated to the guest domains, and shuts down the virtual machine 130, thereby completing the shutdown of the execution server 100.

The following describes a process of shutting down guest domains (guest shutdown) at step S16.

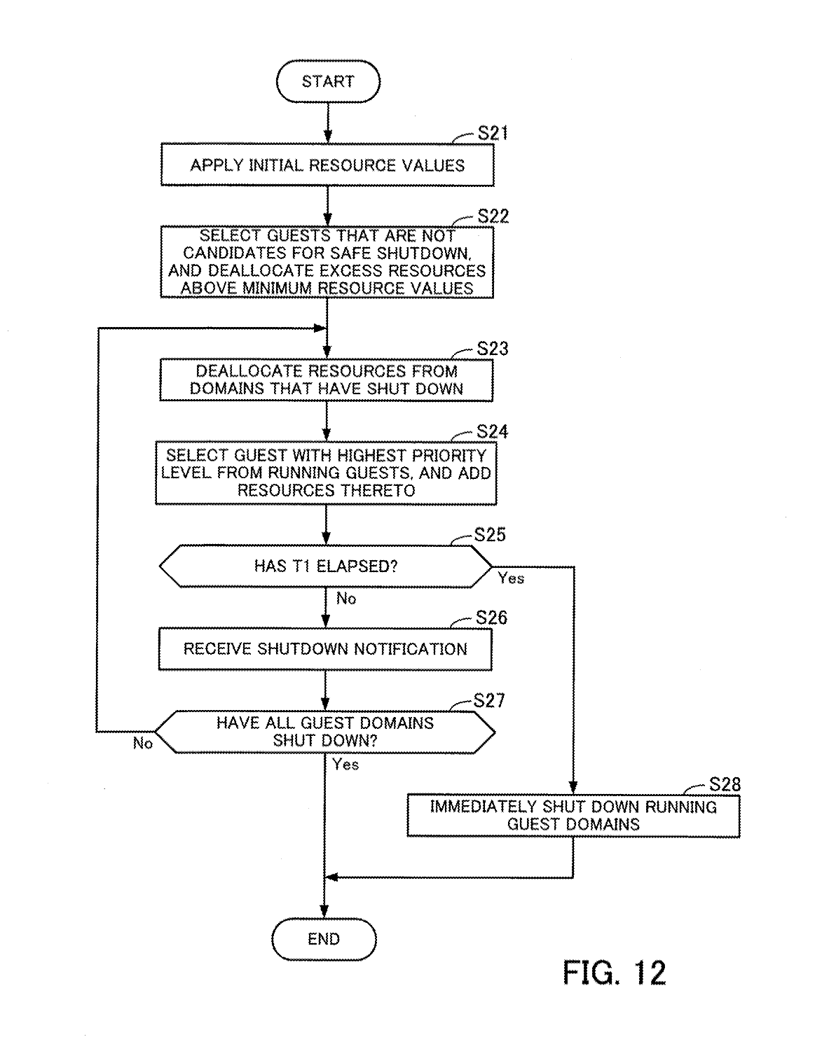

FIG. 12 is a flowchart illustrating an example of a guest shutdown process according to the second embodiment. The process of FIG. 12 will be described step by step.

(Step S21) The management unit 132 obtains initial resource values from the initial resource value table 131c stored in the storage unit 131. The management unit 132 changes the amount of resources allocated to each guest domain to the initial resource values. Referring to the example of the initial resource value table 131c, the initial values for the number of vCPUs and the size of memory are 16 and 32 GB, respectively. Therefore, the management unit 132 changes the number of vCPUs allocated to each guest domain to 16, and changes the size of memory allocated to each guest domain to 32 GB. For example, referring to the management table 131b, the number of vCPUs allocated to the virtual machine 140 (guest domain name “G1”) is 24 and the number of vCPUs allocated to each of the virtual machine 180 (guest domain name “G5”) and the virtual machine 190 (guest domain name “G6”) is 8. Therefore, the management unit 132 changes the number of vCPUs allocated to each of the virtual machines 140, 180, and 190 to 16. If the number of vCPUs already allocated matches the initial value, the resource allocation may not be changed. Even when a guest domain is in the middle of a shutdown process, resources may be deallocated from or added to the guest domain without interruption of the shutdown process (the same applies hereafter). In addition, it is so designed that, at the time of applying the above initial resource values, the management unit 132 selects a virtual machine with the highest priority level among running virtual machines. That is, the management unit 132 selects a virtual machine with the highest priority level to collectively allocate resources thereto. This selection is made either before or after the above initial resource values are applied.

(Step S22) The management unit 132 selects guest domains that are not candidates for safe shutdown with reference to the management table 131b stored in the storage unit 131. The management unit 132 obtains the minimum resource values from the minimum resource value table 131b stored in the storage unit 131. The management unit 132 deallocates excess resources above the minimum resource values from the guest domains that are not candidates for safe shutdown. Referring to the example of the management table 131b, the virtual machines 180 and 190 each have a safe shutdown flag of “false”. Therefore, the management unit 132 selects the virtual machines 180 and 190. Referring to the example of the minimum resource value table 131d, the minimum values for the number of vCPUs and the size of memory are 8 and 16 GB, respectively. Therefore, the management unit 132 changes the number of vCPUs allocated to each of the virtual machines 180 and 190 from 16 to 8 (i.e., deallocates a total of 16 vCPUs therefrom). In addition, the management unit 132 changes the size of memory allocated to each of the virtual machines 180 and 190 from 32 GB to 16 GB (i.e., deallocates a total of 32 GB memory therefrom). In this connection, since guest domains that are not candidates for safe shutdown have lower priority levels than guest domains that are candidates for safe shutdown, the guest domains selected at step S22 have lower priority levels than a guest domain currently with the highest priority level.

(Step S23) The management unit 132 selects domains that have shut down with reference to the management table 131b. The management unit 132 deallocates all resources from the domains that have shut down with reference to the management table 131b.

(Step S24) The management unit 132 selects a guest domain with the highest priority level from the running guest domains, with reference to the management table 131b. The management unit 132 allocates the selected guest domain free resources including resources deallocated at steps S22 and S23 (addition of resources).

(Step S25) The management unit 132 determines whether the guest domain shutdown time (T1) has elapsed or not, with reference to the power supply time cable 131a stored in the storage unit 131. If T1 has not elapsed, the process proceeds to step 326. Otherwise, the process proceeds to step S28.

(Step S26) The hypervisor 120 receives a shutdown notification indicating completion of shutdown from a guest domain immediately before the guest domain completes its shutdown. This shutdown notification includes, for example, a guest domain name. When receiving the shutdown notification, the hypervisor 120 gives the shutdown notification to the management unit 132. When receiving the shutdown notification, the management unit 132 changes the setting of a corresponding shutdown flag in the management table 131b. More specifically, with respect to the guest domain that is the transmission source of the shutdown notification, the management unit 132 changes the shutdown flag from “false” to “true”.

(Step S27) The management unit 132 determines whether all of the guest domains have shut down or not. If all of the guest domains have shut down, the process is completed. If there is any guest domain that is running, the process proceeds back to step S23. For example, if all of the shutdown flags are “true” in the management table 131b, this means that all of the guest domains have shut down. If one or more shutdown flags are “false”, this means that there are one or more running guest domains.

(Step S28) The management unit 132 immediately shuts down the running quest domains. Even if these guest domains are in the middle of their shutdown processes, the management unit 132 forcibly shuts down the guest domains.

As described above, the management unit 132 deallocates resources from guest domains that are not candidates for safe shutdown, and allocates them to a guest domain with high priority level. In addition, the management unit 132 deallocates resources from guest domains that have shut down, and allocates them to the guest domain with high priority level. Each time any guest domain completes its shutdown, the management unit 132 deallocates resources from the guest domain that has shut down and allocates them to the guest domain with high priority level.

Deallocating resources from guest domains with low priority level and collectively allocating them to a guest domain with high priority level make it possible to complete the shutdown of the guest domain with high priority level in a short time, as compared with the case where such resources are not collectively allocated.

Further, changing the amount of resources allocated to each guest domain to the same initial resource values, as in step S21, suppresses variations in the amount of resources for the guest domains. For example, immediately before a power outage occurs, there may be a guest domain that has a small amount of allocated resources because its workload for processing is small. By applying the initial resource values, such a guest domain having a small amount of allocated resources is allowed to perform its shutdown process with the expected amount of allocated resources.

Still further, deallocating resources from guest domains that are not candidates for safe shutdown and allocating them to a guest domain with the highest priority level make it possible to reduce the time to perform the shutdown process of the guest domain with the highest priority level. At this time, resources are not deallocated from guest domains that are candidates for safe shutdown, and therefore each guest domain that is a candidate for safe shutdown is allowed to keep on performing its shutdown process with the amount of allocated resources set by the initial resource values.

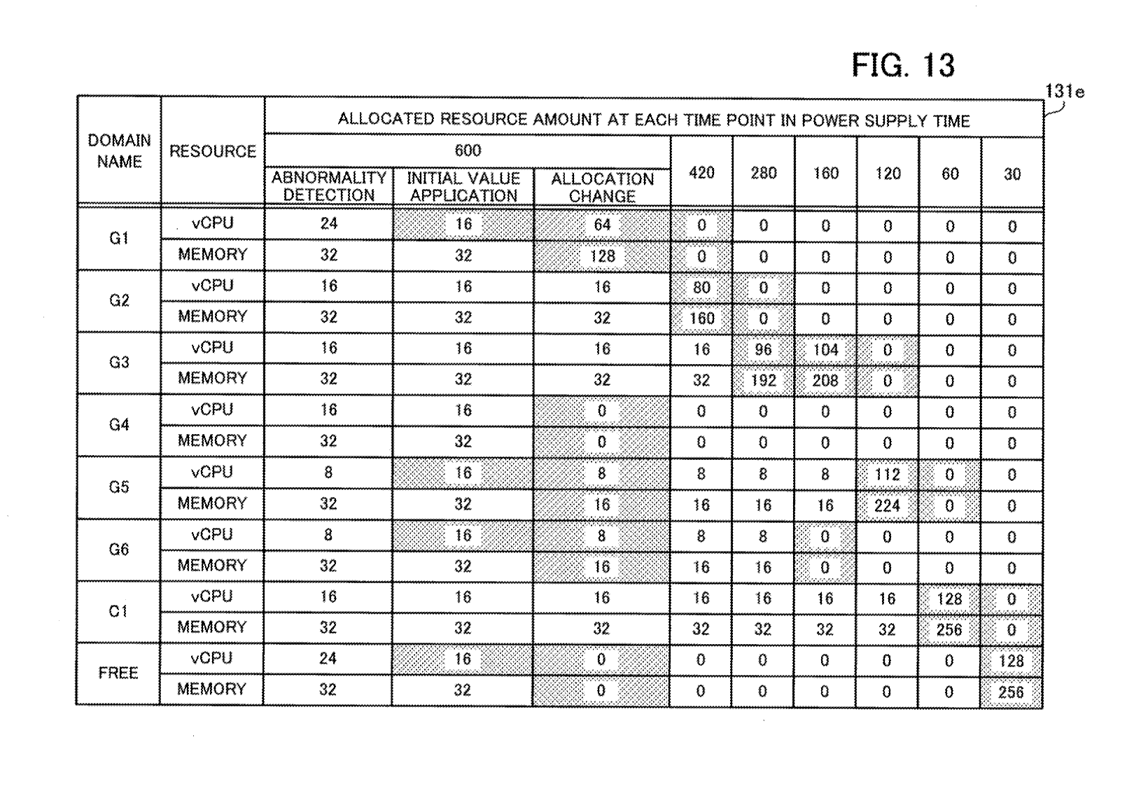

FIG. 13 illustrates an example of transitions in the amount of allocated resources according to the second embodiment. A transition table 131e includes the following fields: domain name, resource, and allocated resource amount at each time point in power supply time.

The domain name field contains the machine name of a virtual machine. In this connection, the last line is used for information about free resources, and therefore “free” is indicated. The resource field contains the type name (vCPU or memory) of resources allocated to the domain. In this connection, the last two lines each contains the type name (vCPU or memory) of free resources, which are not allocated to any domains. The field for allocated resource amount at each time point in power supply time indicates the amount of resources allocated to the domain at each time point until the power supply time elapses from the start of power supply from a battery. vCPU is expressed by the number of vCPUs, and memory is expressed in GB. For example, resources allocable to the virtual machines on the execution server 100 are 128 vCPUs and 256 GB of memory in total.

For example, the following plurality of time points are considered in the power supply time: 600 seconds left, 420 seconds left, 280 seconds left, 160 seconds left, 120 seconds left, 60 seconds left, and 30 seconds left. In this connection, the term “left” is omitted in the transition table 131e. In addition, the term “time point” has some allowable time window.

The time point of 600 seconds left is when power supply from the battery starts because of a power outage. This time point further has subfields: abnormality detection, initial value application (to resources), and (resource) allocation change.

The time point of 420 seconds left is when the virtual machine 140 (domain name “G1”) completes its shutdown. The time point of 280 seconds left is when the virtual machine 150 (domain name “G2”) completes its shutdown. The time point of 160 seconds left is when the virtual machine 190 (domain name “G6”) completes its shutdown. The time point of 120 seconds left is when the virtual machine 160 (domain name “G3”) completes its shutdown. The time point of 60 seconds left is when the virtual machine 180 (domain name “G5”) completes its shutdown. The time point of 30 seconds left is when the virtual machine 130 (domain name “C1”) completes its shutdown.

In this case, referring to the power supply time table 131a, the management table 131b, the initial resource value table 131c, and the minimum resource value table 131d, for example, the amount of resources allocated to each virtual machine is changed as follows.

First, the amount of resources allocated to each virtual, machine at the time of a power source abnormality being detected is as follows. The virtual machine 140 has 24 vCPUs and 32 GB of memory. Each of the virtual machines 130, 150, 160, and 170 has 16 vCPUs and 32 GB of memory. Each of the virtual machines 180 and 190 has 8 vCPUs and 32 GB of memory. As free resources, there are 24 vCPUs and 32 GB of memory. When the power source abnormality is detected, the management unit 132 causes the virtual machines 140, 150, 160, 170, 180, and 190 to start shutting down. In this connection, the virtual machine 170 has shut down by this time. Hereinafter, only changes in the allocation from the immediately-previous time point will be described, and unchanged allocation will not be described.

When the management unit 132 applies the initial resource values, the number of vCPUs allocated to each of the virtual machines 140, 180, and 190 is changed to 16. In the transition table 131e, the changes from the immediately-previous time point are indicated by hatching (the same applies hereinafter). At this time, the number of free vCPUs becomes 16. This is because, as compared with the time of the abnormality being detected, the number of vCPUs is reduced by 8 for the virtual machine 140, and the number of vCPUs is increased by 8 for each of the virtual machines 180 and 190 (a total of 16). That is, although there were 24 free vCPUs at the time of the abnormality being detected, the number of free vCPUs becomes 16 (=24+8−16) through the application of the initial values.

The amount of resources allocated to each virtual machine after the management unit 132 changes the resource allocation is as follows. Each of the virtual machines 180 and 190 has 8 vCPUs and 16 GB of memory. This is because resources were deallocated based on the minimum resource value table 131d. In addition, the virtual machine 170 has 0 vCPU and 0 GB of memory because the virtual machine 170 has shut down. In addition, the number of free vCPUs is zero and the size of free memory is 0 GB because free resources were allocated to the virtual machine 140 with the highest priority level among the guest domains performing their shutdown processes. Since the resources deallocated from the virtual machines 170, 180, and 190 and the free resources were allocated to the virtual machine 140, the virtual machine 140 has 64 vCPUs (=16+8+8+16+16) and 128 GB of memory (=32+16+16+32+32).

At the time point of 420 seconds left, the virtual machine 140 completes its shutdown. Then, the management unit 132 changes the resource allocation. More specifically, the number of vCPUs and the memory size for the virtual machine 140 are changed to zero and 0 GB, respectively. This means that 64 vCPUs and 128 GB of memory are deallocated from the virtual machine 140. The deallocated resources are added to the virtual machine 150 with the highest priority level among the guest domains performing their shutdown processes. As a result, the virtual machine 150 has 80 vCPUs (=16+64) and 160 GB of memory (=32+128).

At the time point of 280 seconds left, the virtual machine 150 completes its shutdown. Then, the management unit 132 changes the resource allocation. More specifically, the number of vCPUs and the memory size for the virtual machine 150 are changed to zero and 0 GB, respectively. This means that 80 vCPUs and 160 GB of memory are deallocated from the virtual machine 150. The deallocated resources are added to the virtual machine 160 with the highest priority level among the guest domains performing their shutdown processes. As a result, the virtual machine 160 has 96 vCPUs (=16+80) and 192 GB of memory (=32.160).

At the time point of 160 seconds left, the virtual machine 190 completes its shutdown. Then, the management unit 132 changes the resource allocation. More specifically, the number of vCPUs and the memory size for the virtual machine 190 are changed to zero and 0 GB, respectively. This means that 8 vCPUs and 16 GB of memory are deallocated from the virtual machine 190. The deallocated resources are added to the virtual machine 160 with the highest priority level among the guest domains performing their shutdown processes. As a result, the virtual machine 160 has 104 vCPUs (=96+8) and 208 GB of memory (=192+16).

At the time point of 120 seconds left, the virtual machine 160 completes its shutdown. Then, the management unit 132 changes the resource allocation. More specifically, the number of vCPUs and the memory size for the virtual machine 160 are changed to zero and 0 GB, respectively. This means that 104 vCPUs and 208 GB of memory are deallocated from the virtual machine 160. The deallocated resources are added to the virtual machine 180 that is the only one virtual machine that is performing its shutdown process. As a result, the virtual machine 180 has 112 vCPUs (=8+104) and 224 GB of memory (=16+208).

At the time point of 60 seconds left, the guest domain shutdown time (T1) elapses. Therefore, even if the virtual machine 180 is in the middle of the shutdown process, the management unit 132 forcibly shuts down the virtual machine 180. Then, the management unit 132 changes the resource allocation. More specifically, the number of vCPUs and the memory size for the virtual machine 180 are changed to zero and 0 GB, respectively. This means that 112 vCPUs and 224 GB of memory are deallocated from the virtual machine 180. The deallocated resources are added to the virtual machine 130 serving as a control domain. As a result, the virtual machine 130 has 128 vCPUs (=16+112) and 256 GB of memory (=32+224). Then, the management unit 132 causes the virtual machine 130 to start shutting down.

At the time point of 30 seconds left, the virtual machine 130 completes its shutdown. Therefore, the number of vCPUs and the memory size for the virtual machine 130 are changed to zero and 0 GB, respectively, so that all of the vCPUs and memory become free (that is, the number of free vCPUs is 128 and the size of free memory is 256 GB). Then, the hypervisor 120 shuts down. As a result, the execution server 100 shuts down within the power supply time.

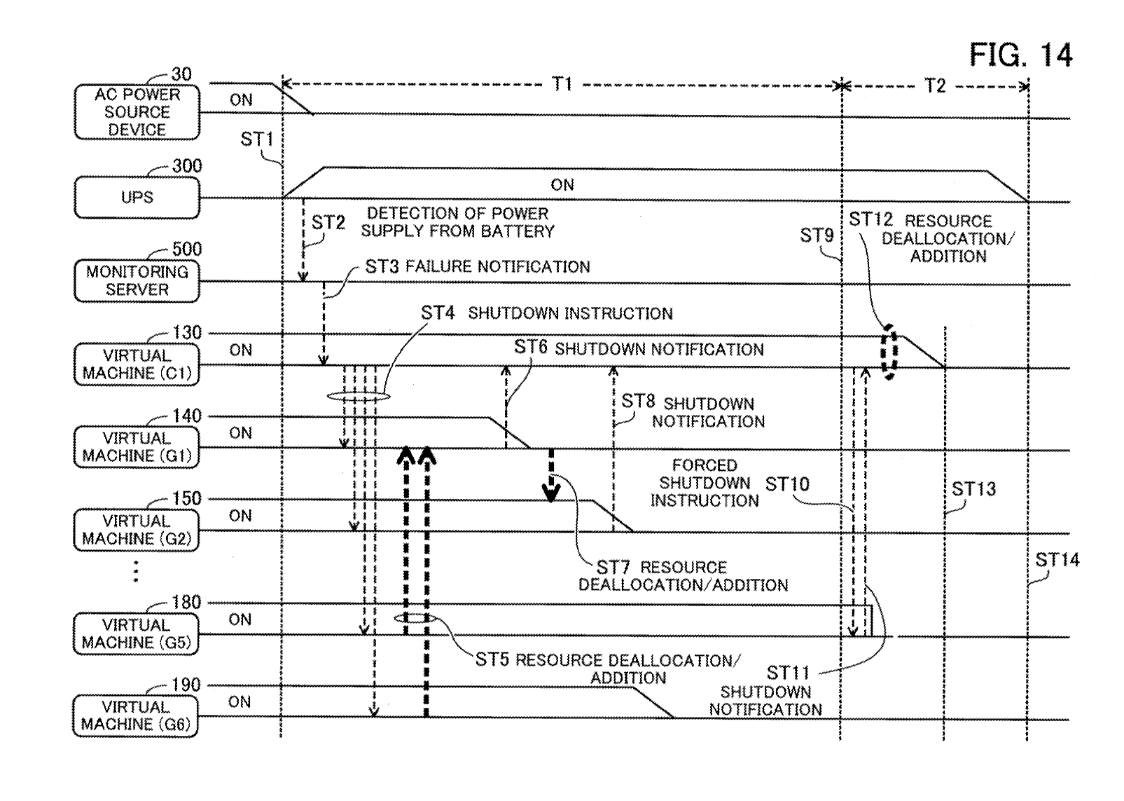

FIG. 14 is a sequence diagram for a power source failure according to the second embodiment. The process of FIG. 14 will be described step by step. A part of the flow of FIG. 13 will be used in the description of FIG. 14.

(Step ST1) The AC power source device 30 decreases its power supply performance. For example, the UPS 300 detects an abnormality in the AC power source device 30 by detecting that supplied electrical voltage falls below a threshold. Then, the UPS 300 starts power supply from the battery 308.

(Step ST2) The UPS 300 sends a notification of the power source abnormality to the monitoring server 500. The monitoring server 500 detects from this notification that the power supply from the battery 308 to the execution server 100 has started.

(Step ST3) The monitoring server 500 sends a notification of power source failure to the virtual machine 130. When receiving the notification of supply source failure, the virtual machine 130 determines a guest domain shutdown time (T1) and a control domain shutdown time (T2) on the basis of the power supply time indicated in the notification, and registers these times in the power supply time table 131a. The virtual machine 130 starts counting for T1. In this connection, a time interval between steps ST1 to ST3 is, for example, several seconds at the most, and is within one second if it is short.

(Step ST4) The virtual machine 130 causes the virtual machines 140, 150, 160, 180, and 190 to start their shutdown processes by issuing a shutdown instruction. In this connection, since the virtual machine 170 has already shut down, the shutdown instruction is not issued thereto.

(Step ST5) The virtual machine 130 changes the amount of resources allocated to each guest domain to the initial values. The virtual machine 130 deallocates excess resources above the minimum resource values from the virtual machines 180 and 190 that are not candidates for safe shutdown and adds them to the virtual machine 140. In addition, the virtual machine 130 adds, to the virtual machine 140, resources deallocated from the virtual machine 170 that has already shut down. Furthermore, the virtual machine 130 adds free resources to the virtual machine 140 as well. The virtual machine 140 is a guest domain with the highest priority level among the guest domains currently performing their shutdown processes.

(Step ST6) The virtual machine 140 gives a shutdown notification to the virtual machine 130 via the hypervisor 120. By receiving the shutdown notification, the virtual machine 130 detects that the virtual machine 140 is to complete its shutdown process.

(Step ST7) When the virtual machine 140 completes its shutdown, the virtual machine 130 deallocates all resources from the virtual machine 140, and adds them to the virtual machine 150. The virtual machine 150 is a guest domain with the highest priority level among the guest domains currently performing their shutdown processes.

(Step ST8) The virtual machine 150 gives a shutdown notification to the virtual machine 130 via the hypervisor 120. By receiving the shutdown notification, the virtual machine 130 detects that the virtual machine 150 is to complete its shutdown process. Thereafter, each time any virtual machine completes its shutdown process, the virtual machine 130 deallocates resources from the virtual machine and adds them to a guest domain with the highest priority level among the guest domains performing their shutdown processes at that time, as in step ST7.

(Step ST9) The virtual machine 130 detects that the guest domain shutdown time (T1) has elapsed.

(Step ST10) The virtual machine 130 instructs the virtual machine 180 performing its shutdown process to forcibly shut down.

(Step ST11) The virtual machine 180 gives a shutdown notification to the virtual machine 130 via the hypervisor 120. By receiving the shutdown notification, the virtual machine 130 detects that the virtual machine 180 accepted the forced shutdown and is to forcibly complete its shutdown process.

(Step ST12) The virtual machine 130 deallocates all resources from the virtual machine 180 and adds them to the virtual machine 130. Then, the virtual machine 130 starts to perform its shutdown process.

(Step ST13) The virtual machine 130 completes the shutdown process. In addition, the hypervisor 120 completes its shutdown. As a result, the execution server 100 completes its shutdown within the power supply time.

(Step ST14) The UPS 300 stops the power supply from the battery 308.

As described above, it is possible to collectively allocate resources to a guest domain with high priority level, so as to thereby improve the possibility that the guest domain with high priority level completes its shutdown safely. On the other hand, a guest domain with low priority level may not complete its shutdown within the guest domain shutdown time (T1). Therefore, a low priority level may be given to a guest domain that does not need to be shut down safely. Even if a guest domain in the middle of its shutdown process is forcibly shut down when T1 elapses, this causes less influence on the entire system than the case of forcibly shutting down a guest domain with high priority level.

The following describes a comparison example with respect to a process to be performed at the time of a power source failure according to the second embodiment. An example to be compared is the case of not changing resource allocation to each guest machine, and is compared with the case of FIG. 14.

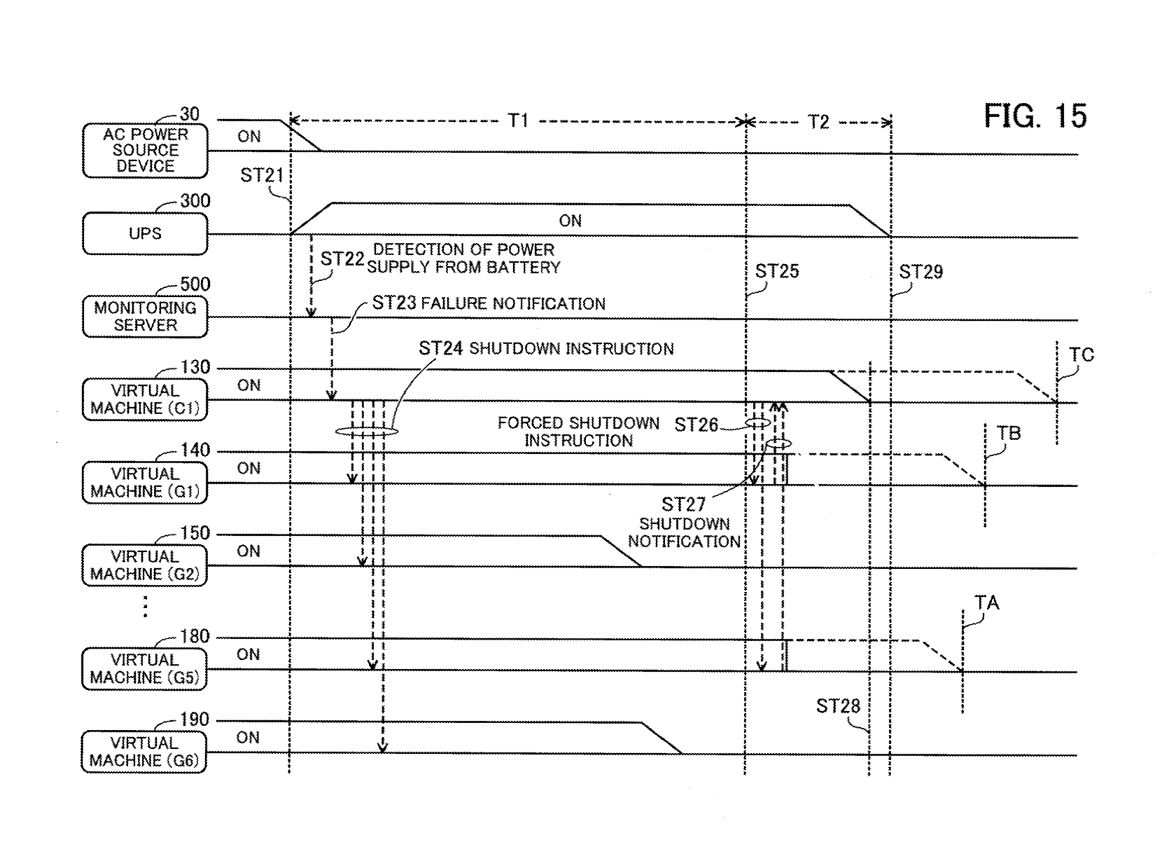

FIG. 15 is another sequence diagram for a power source failure. The process of FIG. 15 will be described step by step. Units used in the second embodiment are used here as entities that perform the following processes for convenience of explanation.

(Step ST21) The AC power source device 30 decreases its power supply performance. For example, the UPS 300 detects an abnormality in the AC power source device 30 by detecting that supplied electrical voltage falls below a threshold. Then, the UPS 300 starts power supply from the battery 308.

(Step ST22) The UPS 300 sends a notification of the power source abnormality to the monitoring server 500. The monitoring server 500 detects from this notification that the power supply from the battery 308 to the execution server 100 has started.

(Step ST23) The monitoring server 500 sends a notification of power source failure to the virtual machine 130. When receiving the notification of power source failure, the virtual machine 130 determines a guest domain shutdown time (T1) and a control domain shutdown time (T2) on the basis of the power supply time indicated in the notification, and registers these times in the power supply time table 131a.

(Step ST24) The virtual machine 130 causes the virtual machines 140, 150, 160, 170, 180, and 190 to start their shutdown processes by giving a shutdown instruction thereto. Thereafter, the guest domains sequentially complete their shutdown processes. In this connection, there may be a guest domain that does not complete its shutdown process within the guest domain shutdown time (T1).

(Step ST25) The virtual machine 130 detects that the guest domain shutdown time (T1) has elapsed.

(Step ST26) The virtual machine 130 instructs the guest domains performing their shutdown processes to forcibly shut down. For example, the virtual machines 140 and 180 are guest domains that are currently performing their shutdown processes. The virtual machine 130 instructs, via the hypervisor 120, the virtual machines 140 and 180 to forcibly shut down.

(Step ST27) The virtual machines 140 and 180 each give a shutdown notification to the virtual machine 130 via the hypervisor 120. The virtual machine 130 receives the shutdown notifications and detects from the shutdown notifications that the virtual machines 140 and 180 accepted the forced shutdown and are to forcibly complete their shutdown processes. Then the virtual machine 130 starts the shutdown process.

(Step ST28) The virtual machine 130 completes the shutdown process and then the hypervisor 120 shuts down. As a result, the execution server 100 shuts down.

(Step ST29) The UPS 300 stops the power supply from the battery 308.

FIG. 15 exemplifies three times TA, TB, and TC that come after step ST29. Each time TA, TB, and TC represents a time point at which a virtual machine completes its shutdown process in the case where the virtual machine is not forcibly shut down even after the elapse of T1.

It is supposed that the time TA represents a time point at which the virtual machine 180 completes its shutdown process, the time TB represents a time point at which the virtual machine 140 completes its shutdown process, and the time TC represents a time point at which the virtual machine 130 completes its shutdown process. If the virtual machines 140 and 180 are not forcibly shut down after step ST25, they would not complete the shutdown safely within the power supply time (T1+T2) of the power supply from the battery 308 of the UPS 300. Since the virtual machine 130 starts its shutdown process after the guest machines complete their shutdown, the virtual machine 130 fails to complete its shutdown safely within the power supply time.

FIG. 15 illustrates the example in which the virtual machines 140 and 180 are forcibly shut down at step ST26 and at least the virtual machine 130 is shut down safely. However, there may be a virtual machine of high significance, like the virtual machine 140 (that performs the functions of the DB server and significant business processing), among the guest domains that are to be forcibly shut down. If such a virtual machine of high significance is forcibly shut down, data inconsistency may occur and thus processing may fail to be performed properly. In addition, this causes problems in that it will take time to recover from such a failure and operational costs will be needed. That is, forced shutdown of a virtual machine of high significance has a great influence on the entire system.

To deal with this matter, according to the second embodiment, for an urgent shutdown of guest domains, higher priority levels are given to virtual machines of higher significance. Then resources are deallocated from virtual machines with low priority level and added to the virtual machines with high priority level. This makes it possible to preferentially cause the virtual machines of high significance to complete their shutdown processes. In this way, it is possible to shut down guest domains efficiently.

Further, high priority levels are given to guest domains that are candidates for safe shutdown, and low priority levels are given to guest domains that are not candidates for safe shutdown. This reduces the possibility that guest domains that are candidates for safe shutdown fail to complete their shutdown within the guest domain shutdown time (T1). That is to say, in this case, guest domains that fail to complete their shutdown are probably guest domains that are not candidates for safe shutdown. This reduces an influence of the forced shutdown of guest domains on the entire system.

Still further, for example, in the case where the times T1 and T2 are fixed values, the virtual machine 130 serving as a control domain may not be shut down safely if the battery 308 is not sufficiently charged. To deal with this matter, the management unit 132 determines the guest domain shutdown time (T1) and the control domain shutdown time (T2) on the basis of the power supply time for power supply from the battery 308. Therefore, the time to perform the forced shutdown may be determined appropriately based on the charged amount of the battery 308. This increases the possibility that the virtual machine 130 serving as a control domain completes its shutdown even if the battery 308 is not sufficiently charged. However, the times T1 and T2 may be set to fixed values.

Still further, after all guest domains complete their shutdown, all free resources are added to the virtual machine 130 serving as a control domain to shut down the virtual machine 130. This also reduces the time taken to shut down the virtual machine 130.

In this connection, there is a tendency that allocation of more vCPUs and more memory leads to completing a shutdown process in a shorter time. The following describes a specific example.

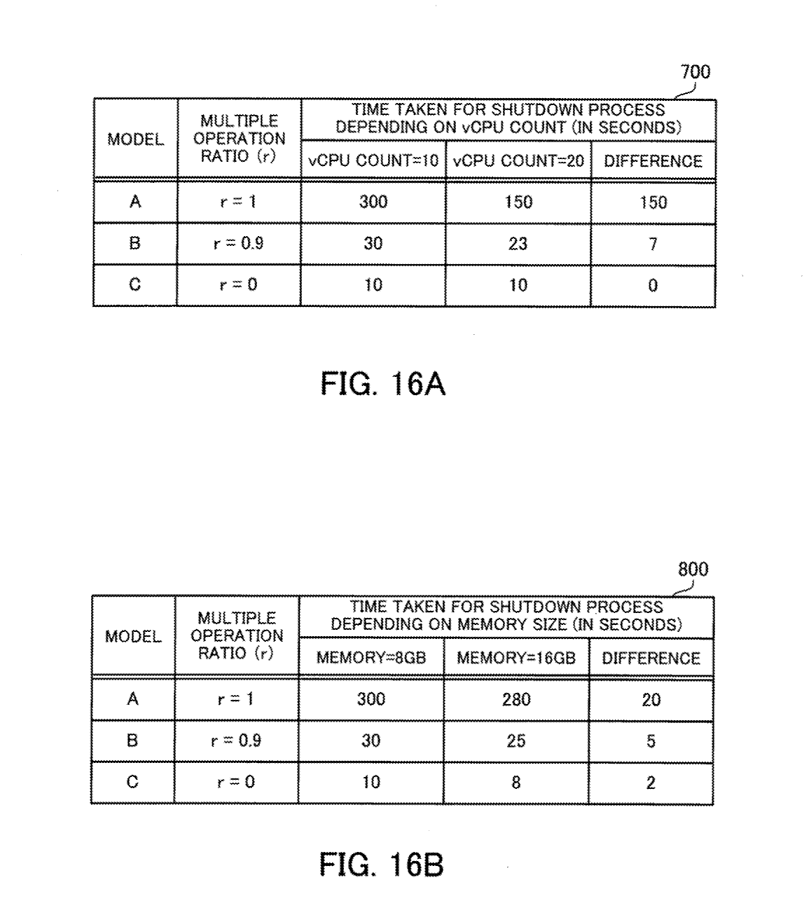

FIGS. 16A and 16B illustrate examples of the time taken for a shutdown process with different amounts of allocated resources. FIG. 16A illustrates a table 700 that exemplifies the times taken for a shutdown process with different numbers of vCPUs. FIG. 16B illustrates a table 800 that exemplifies the times taken for a shutdown process with different memory sizes.

The table 700 includes the following fields: model, multiple operation ratio (r), and time taken for shutdown process depending on vCPU count.

The model field contains information identifying the model of a shutdown process. All models represent how to shut down a virtual machine, but include different contents (different numbers of processes to be shut down, etc.) of the shutdown process. The multiple operation ratio (r) field indicates a ratio of parts for which multiple operation (parallel processing) is possible to the entire shutdown process in the model. The field for time taken for shutdown process depending on vCPU count indicates the time taken to perform the shutdown process of a virtual machine in the model. The time is expressed in seconds. As vCPU counts, 10 and 20 are exemplified. In this connection, the memory size is the same in the both cases. In addition, a difference in the time taken between these cases is also indicated.

In the case of the model “A”, r=1. This means that multiple operation is possible for the entire shutdown process. For example, a virtual machine having 10 vCPUs takes 300 seconds to perform a shutdown process based on the model “A”. If this virtual machine has 20 vCPUs with the same memory size, it takes 150 seconds to perform the shutdown process. The time difference is 150 seconds. That is to say, the more vCPUs, the shorter the time taken.

In the case of the model “B”, r=0.9. This means that multiple operation is possible for 90% of the entire shutdown process. For example, a virtual machine having 10 vCPUs takes 30 seconds to perform a shutdown process based on the model “B”. If this virtual machine has 20 vCPUs with the same memory size, it takes 23 seconds to perform the shutdown process. The time difference is 7 seconds. That is to say, the more vCPUs, the shorter the time taken.

In the case of the model “C”, r=0. That means that multiple operation is not possible for any part of the entire shutdown process. For example, a virtual machine having 10 vCPUs takes 10 seconds to perform a shutdown process based on the model “C”. If this virtual machine has 20 vCPUs with the same memory size, it takes 10 seconds to perform the shutdown process. There is no time difference.

In this connection, it is known that a speedup ratio (E) (E is a real number) of processing based on the number of vCPUs (n) (n is an integral number of one or greater) and a ratio (r) (r is a real number of 0 or greater or 1 or less) of parts for which multiple operation is possible to the entire process is represented by the following equation (1).

$$E = \frac{1}{1 - r + \frac{r}{n}} \qquad ( 1 )$$

As described above, with respect to a shutdown process, the more vCPUs a virtual machine has, the shorter the time taken to complete the shutdown process. Especially, the shutdown process may be controlled by an OS running on the virtual machine. The OS may make at least part of the shutdown process performed in multiple operation. Therefore, there is a high possibility that the time taken to perform the shutdown process is reduced by increasing the number of vCPUs.

The table 800 includes the following fields: model, multiple operation ratio (r), and time taken for shutdown process depending on memory size.

The model field and the multiple operation ratio (r) field have the same information setting as those in the table 700. The field for time taken for shutdown process depending on memory size indicates the time taken to perform the shutdown process of a virtual machine in the model. The time is expressed in seconds. As memory sizes, 8 GB and 16 GB are exemplified. In this connection, the number of vCPUs is the same in the both cases. In addition, a difference in the time taken between these cases is also indicated.

For example, a virtual machine having 8 GB of memory takes 300 seconds to perform a shutdown process based on the model “A” (r=1). If this virtual machine has 16 GB of memory with the same number of vCPUs, it takes 280 seconds to perform the shutdown process. The time difference is 20 seconds. That is to say, the more the memory size, the shorter the time taken.

For example, a virtual machine having 8 GB of memory takes 30 seconds to performs a shutdown process based on the model “B” (r=0.9). If this virtual machine has 16 GB of memory with the same number of vCPUs, it takes 25 seconds to perform the shutdown process. The time difference is 5 seconds. That is to say, the more the memory size, the shorter the time taken.

For example, a virtual machine having 8 GB of memory takes 10 seconds to perform a shutdown process based on the model “C” (r=0). If this virtual machine has 16 GB of memory with the same number of vCPUs, it takes 8 seconds to perform the shutdown process. The time difference is 2 seconds. That is to say, the more the memory size, the shorter the time taken.

As described above, with respect to a shutdown process, the more memory size a virtual machine has, the shorter the time taken to complete the shutdown process. That is to say, it is possible to reduce the time taken to perform the shutdown process by increasing the memory size.

### Third Embodiment

Hereinafter, a third embodiment will be described. Differential features from the above-described second embodiment will mainly be described, and the same features will not be described again.

In the second embodiment, after a shutdown instruction is issued to each guest domain, the amount of resources allocated to each guest domain is changed to initial values. On the other hand, it may also be possible to change the amount of resources allocated to each guest domain without changing the amount of resources allocated immediately before a power outage (without initial values applied).

For example, during operation, more resources may be allocated to a guest domain having a heavier workload. Therefore, a guest domain allocated a large amount of resources may be in the middle of high-load processing immediately before a power outage. If a shutdown process starts under this situation, load for interrupting the high-load processing is probably imposed. Therefore, it takes time for the guest domain to perform the shutdown process. To deal with this matter, the method of the third embodiment may be employed.

An information processing system and devices of the third embodiment are the same as those of the second embodiment explained with reference to FIG. 2. In addition, the exemplary hardware and software for each device in the third embodiment are the same as those in the second embodiment described with reference to FIGS. 3 to 6. Thus, the same names and the same reference numerals of the second embodiment are used for the corresponding devices of the third embodiment.

Differential features from the second embodiment are that a storage unit 131 further stores an allocated resource threshold table and that a management unit 132 changes resource allocation without changing the amount of resources allocated to each guest domain to initial values.

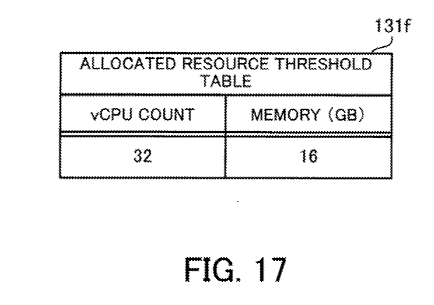

FIG. 17 illustrates an allocated resource threshold table according to the third embodiment. An allocated resource threshold table 131f is stored in the storage unit 131. The allocated resource threshold table 131f includes the following fields: vCPU count and memory (GB).

The vCPU count field indicates the minimum number of vCPUs (threshold for the number of vCPUs) needed for a guest domain with the highest priority level among the guest domains performing a shutdown process at a certain time point. The memory (GB) field indicates the minimum size of memory (threshold for memory size) needed for a guest domain with the highest priority level among the guest domains performing a shutdown process at a certain time point. For example, the threshold for the number of vCPUs is 32, and the threshold for memory size is 16 GB. An appropriate threshold for operation may be set for each resource type.

The following describes a procedure of the third embodiment. An exemplary process to be performed at the time of a power source failure in the third embodiment is the same as that in the second embodiment described with reference to FIG. 11. However, a guest shutdown process that is performed at step S16 of FIG. 11 is different from that of FIG. 12.

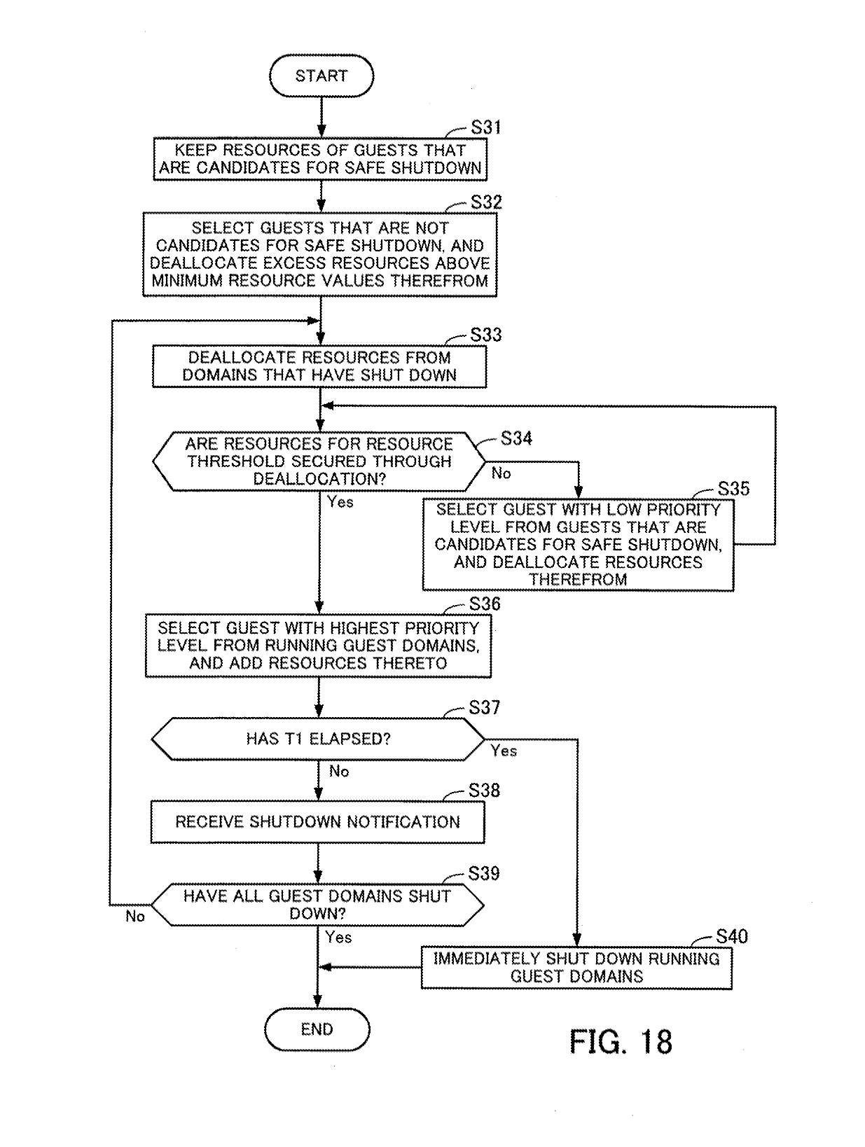

FIG. 18 is a flowchart illustrating an example of a guest shutdown process according to the third embodiment. The process of FIG. 18 will be described step by step.

(Step S31) The management unit 132 keeps the amount of resources allocated to guest domains that are candidates for safe shutdown, with reference to a management table 131b stored in the storage unit 131. From the guest domains that are candidates for safe shutdown, any resources are not deallocated at the following step S32. In addition, the management unit 132 is designed to select a virtual machine with the highest priority level among running virtual machines. That is, the management unit 132 selects a virtual machine with the highest priority level to collectively allocate resources thereto.

(Step S32) The management unit 132 selects guest domains that are not candidates for safe shutdown with reference to the management table 131b. The management unit 132 obtains the minimum resource values from a minimum resource value table 131d stored in the storage unit 131. The management unit 132 then deallocates excess resources above the minimum resource values from the guest domains that are not candidates for safe shutdown. In this connection, the management unit 132 does not deallocate any resources from a guest domain having a less amount of resources than the minimum resource values. Since guest domains that are not candidates for safe shutdown are given lower priority levels than guest domains that are candidates for safe shutdown, the guest domains selected at step S32 have lower priority levels than the guest domain currently with the highest priority level.

(Step S33) The management unit 132 selects domains that have shut down with reference to the management table 131b. The management unit 132 deallocates all resources from the selected domains with reference to the management table 131b.

(Step S34) The management unit 132 obtains resource thresholds from the allocated resource threshold table 131f stored in the storage unit 131. The management unit 132 determines with reference to the management table 131b whether or not resources satisfying the resource thresholds are secured for the guest domain with the highest priority level among the guest domains performing their shutdown processes. If such resources are not secured, the process proceeds to step S35. If such resources are secured, the process proceeds to step S36. More specifically, the determination of step S34 is made based on whether the amount of resources obtained by adding the resources deallocated at steps S32 and S33 to the current amount of resources allocated to the guest domain with the highest priority level is greater than or equal to a resource threshold or not. If the resource threshold is exceeded, this means that resources equal to or greater than the resource threshold are secured. If the resource threshold is not reached, this means that resources equal to or greater than the resource threshold are not secured. This determination on whether a resource threshold is satisfied or not is made with respect to each of the number of vCPUs and the memory size. If the resource threshold is secured with respect to at least one of them, resources satisfying the resource threshold may be determined to be secured.

(Step 335) The management unit 132 selects a guest domain with the lowest priority level among the guest domains that are candidates for safe shutdown, with reference to the management table 131b. The management unit 132 deallocates excess resources above the minimum resource values from the selected guest domain. At this time, if the selected guest domain has the less amount of allocated resources than the minimum resource values, then no resources are deallocated from the guest domain, and then a guest domain with the next lowest priority level is selected. Then, the management unit 132 makes an attempt to deallocate resources from the currently selected guest domain in the same manner. Then, the process proceeds to step S34. In this connection, at this step S35, no resources may be deallocated from any of the guest domains that are candidates for safe shutdown. In this case, the process may proceed to step S36.

(Step S36) The management unit 132 selects a guest domain with the highest priority level among running guest domains with reference to the management table 131b. The management unit 132 allocates free resources including the resources deallocated at steps S32 and 333 to the selected guest domain (addition of resources). If resources were deallocated at step S35, these resources are allocated to the selected guest domain as well.

(Step S37) The management unit 132 determines whether a guest domain shutdown time (T1) has elapsed or not, with reference to a power supply time table 131a stored in the storage unit 131. If the time T1 has not elapsed, the process proceeds to step S38. If the time T1 has elapsed, the process proceeds to step S40.

(Step S38) The management unit 132 receives a shutdown notification from a guest domain via the hypervisor 120 immediately before the guest domain completes the shutdown. The management unit 132 then changes the setting of a corresponding shutdown flag in the management table 131b. More specifically, the shutdown flag is changed from “false” to “true” with respect to the guest domain that is the transmission source of the shutdown notification.

(Step S39) The management unit 132 determines whether all the guest domains have shut down or not. If all the guest domains have shut down, the process is completed. If there is any guest domain that is running, the process goes back to step S33.

(Step S40) The management unit 132 shuts down the running guest domains immediately. Even if a running guest domain is in the middle of the shutdown process, the management unit 132 forcibly shuts down the guest domain.

As described above, deallocating resources from guest domains with low propriety level and collectively allocating them to a guest domain with high priority level make it possible for the guest domain with high priority level to complete its shutdown process in a short time, as compared with the case where such resources are not collectively allocated thereto.

At this time, the amount of resources allocated to guest domains that are candidates for safe shutdown is kept, as in step S31, so that these guest domains are able to perform their shutdown processes with the immediately previous amount of allocated resources.

If the amount of resources allocated to guest domains that are candidate for safe shutdown is kept, a sufficient amount of resources may not be allocated to a guest domain with the highest priority level immediately after the shutdown process starts. Therefore, resources are first deallocated from guest domains that are not candidates for safe shutdown and guest domains that have shut down, and if the resources are still insufficient, resources are deallocated from guest domains that are candidates for safe shutdown. At this time, resources are deallocated from guest domains in order from the lowest priority level, among the guest domains that are candidates for safe shutdown, so as to keep the resources of guest domains with high priority level as much as possible. As a result, a guest domain with a higher priority level has a higher possibility of performing its shutdown process with an expected amount of allocated resources.

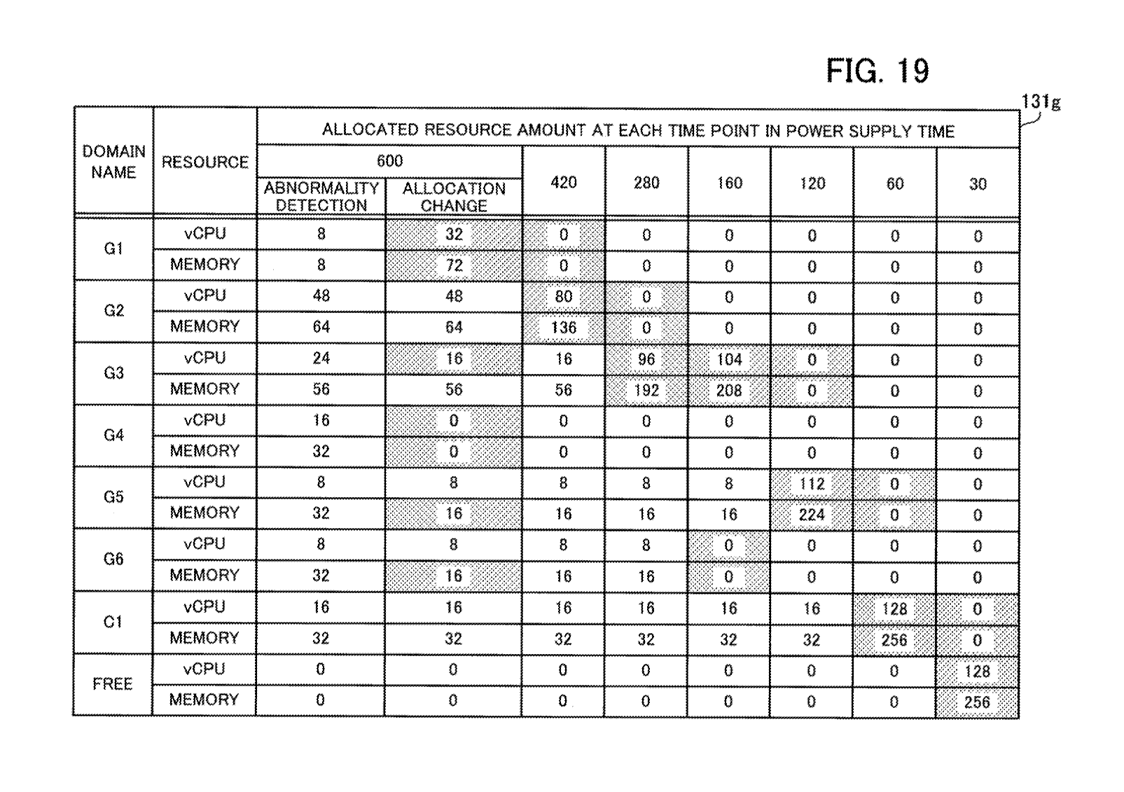

FIG. 19 illustrates an example of transitions in the amount of allocated resources according to the third embodiment. A transition table 131g includes the following fields: domain name, resource, and allocated resource amount at each time point in power supply time. These fields have the same information setting as those of the transition table 131e. In addition, for example, resources allocable to the virtual machines on the execution server 100 are 128 vCPUs and 256 GB of memory in total.

In the transition table 131g, for example, the following plurality of time points are considered in the power supply time: 600 seconds left, 420 seconds left, 280 seconds left, 160 seconds left, 120 seconds left, 60 seconds left, and 30 seconds left. In this connection, the term “left” is omitted in the transition table 131g. In addition, the term “time point” has some allowable time window.

The time point of 600 seconds left is when power supply from a battery starts because of a power outage. This time point further has subfields: abnormality detection and allocation change.

The time point of 420 seconds left is when the virtual machine 140 (domain name “G1”) completes its shutdown. The time point of 280 seconds left is when the virtual machine 150 (domain name “G2”) completes its shutdown. The time point of 160 seconds left is when the virtual machine 190 (domain name “G6”) completes its shutdown. The time point of 120 seconds left is when the virtual machine 160 (domain name “G3”) completes its shutdown. The time point of 60 seconds left is when the virtual machine 180 (domain name “G5”) completes its shutdown. The time point of 30 seconds left is when the virtual machine 130 (domain name “C1”) completes its shutdown.

In this case, referring to the power supply time table 131a, the management table 131b, the minimum resource value table 131d, and the allocated resource threshold table 131f, for example, the amount of resources allocated to each virtual machine is changed as follows.

Note that the amount of resources allocated to each guest domain at the time of a power source abnormality being detected is different from that indicated in the management table 131b. More specifically, the amount of resources allocated to each guest domain at the time of the power source abnormality being detected is as follows.

Each of the virtual machines 130 and 170 has 16 vCPUs and 32 GB of memory. The virtual machine 140 has 8 vCPUs and 8 GB of memory. The virtual machine 150 has 48 vCPUs and 64 GB of memory. The virtual machine 160 has 24 vCPUs and 56 GB of memory. Each of the virtual machines 180 and 190 has 8 vCPUs and 32 GB of memory. As free resources, there are 0 vCPU and 0 GB of memory. When the power source abnormality is detected, the management unit 132 causes the virtual machines 140, 150, 160, 170, 180, and 190 to start shutting down. In this connection, the virtual machine 170 has shut down by this time. Hereinafter, only changes in the allocation from the immediately-previous time point will be described, and unchanged allocation will not be described.

The amount of resources allocated to each virtual machine after the management unit 132 changes the resource allocation is as follows. Each of the virtual machines 180 and 190 has 16 GB of memory reduced from the previous 32G. This is because resources were deallocated based on the minimum resource value table 131d. In the transition table 131g, the changes from the immediately-previous time point are indicated by hatching (the same applies hereinafter). The virtual machine 170 has 0 vCPU and 0 GB of memory. This is because the virtual machine 170 has shut down. The virtual machine 160 has 16 vCPUs reduced from the previous 24. This is because resources were deallocated based on the minimum resource value table 131f. Since the resources deallocated from the virtual machines 160, 170, 180, and 190 were allocated to the virtual machine 140, the virtual machine 140 has 32 vCPUs and 72 GB of memory. More specifically, this allocation change is made as follows.

The virtual machine 140 has the highest priority level among the guest domains performing their shutdown processes immediately after an abnormality is detected. In the case where 16 vCPUs are deallocated from the virtual machine 170, the deallocated 16 vCPUs are added to the virtual machine 140, which has 8 vCPUs at the time of the abnormality being detected, and thereby the virtual machine 140 has 24 vCPUs. This does not satisfy the threshold of 32 set for the number of vCPUs in the allocated resource threshold table 131f. Therefore, the management unit 132 then selects the virtual machine 160 with the lowest priority level among the guest domains (virtual machines 140, 150, and 160) that are candidates for safe shutdown, deallocates excess 8 vCPUs above the minimum resource value (16 vCPUs), and adds the 8 vCPUs to the virtual machine 140. Thereby, the virtual machine 140 has 32 vCPUs (=8+16+8). This is greater than or equal to the threshold of 32 set for the number of vCPUs in the allocated resource threshold table 131f. Therefore, the management unit 132 does not deallocate vCPUs anymore.

Further, in the case where 64 GB of memory is deallocated from the virtual machines 170, 180, and 190, the deallocated 64 GB of memory is added to the virtual machine 140, which has 8 GB of memory at the time of the abnormality being detected, and thereby the virtual machine 140 has 72 GB of memory (=8+16+16+32). This exceeds the threshold of 16 GB set for the memory size in the allocated resource threshold table 131f. Therefore, the management unit 132 does not deallocate memory anymore.

At the time point of 420 seconds left, the virtual machine 140 completes its shutdown. Then, the management unit 132 changes the resource allocation. More specifically, the number of vCPUs and the memory size for the virtual machine 140 are changed to zero and 0 GB, respectively. This means that 32 vCPUs and 72 GB of memory are deallocated from the virtual machine 140. The deallocated resources are added to the virtual machine 150 with the highest priority level among the guest domains performing their shutdown processes. As a result, the virtual machine 150 has 80 vCPUs (=48+32) and 136 GB of memory (=64+72).

The changes in the resource allocation at the subsequent time points (280 seconds left, 160 seconds left, 120 seconds left, 60 seconds left, and 30 seconds left) are the same as indicated in the transition table 131e described with reference to FIG. 13.

As described above, according to the third embodiment, when a power source abnormality is detected, the amount of resources allocated to each guest domain is changed, without applying initial resource values. More specifically, a virtual machine with high priority level, like the virtual machine 150, among virtual machines that are candidates for safe shutdown is allowed to keep the amount of resources allocated at the time of the power source abnormality being detected. There is a possibility that the virtual machine 150 has more resources allocated than the other virtual machines, and performs high-load processing immediately before the abnormality is detected. Therefore, to shut down the virtual machine 150, the high-load processing needs to be interrupted. Accordingly, there is a possibility that it takes more time to perform a shutdown process than a normal time (when the virtual machine 150 does not perform high-load processing). In such a case, the third embodiment does not reduce the amount of resources allocated to the virtual machine 150. This increases a possibility that the virtual machine 150 is able to shut down safely within a guest domain shutdown time (T1).

Further, at least resources for a resource threshold are secured for a guest domain with the highest priority level. This increases a possibility that the guest domain with the highest priority level is able to shut down safely within the guest domain shutdown time (T1).

The second and third embodiments describe the case of adding deallocated resources to a guest domain with the highest priority level among the guest domains performing their shutdown processes, by way of example. However, the deallocated resources may be added to a guest domain other than the guest domain with the highest priority level. Alternatively, the deallocated resources may be added two or more guest domains.

Further, the second and third embodiments describe the case of changing the resource allocation after a shutdown instruction is issued to each guest domain. However, the time to change the resource allocation is not limited thereto. For example, the management unit 132 may change the resource allocation after receiving a notification of power source failure and before issuing a shutdown instruction to each guest domain.

Still further, in the second and third embodiments, the management unit 132 is provided in the virtual machine 130 serving as a control domain. Alternatively, the management unit 132 may be provided in the hypervisor 120.

Still further, although the above describes the execution server 100, the same shutdown method is applicable to the execution server 200.

Still further, the second and third embodiments describe an example of an urgent shutdown in the case where the power supply time for power supply from the battery 308 of the UPS 300 at the time of a power outage is limited. However, the shutdown method is applicable to other cases. For example, the execution server 100 is directly connected to the AC power source device 30, and may be designed to predict a power source failure if output from the AC power source device 30 is not stable. When a power source failure is predicted, it is preferable to shut down the execution server 100 urgently. In this case, the shutdown method of the second or third embodiment may be employed. In this case, a limited time, instead of the power supply time of the UPS 300, may be given to the management unit 132.

Still further, the monitoring server 500 and the management client 600 may be designed to be able to receive an urgent shutdown instruction from the administrator. In this case, the monitoring server 500 and the management client 600 may send a notification of power source failure to the execution servers 100 and 200. When receiving the notification of power source failure, the execution servers 100 and 200 perform their shutdown processes in the same way as described in the second or third embodiment. In this case, instead of the power supply time of the UPS 300 described in the second and third embodiments, a limited time may be entered from the monitoring server 500 or the management client 600. This enables the management unit 132 to determine the above-described times T1 and T2 on the basis of the limited time.

The above-described functions may be implemented by causing a computer to execute an intended program. The program may be recorded on a computer-readable portable recording medium 13. For example, to distribute the program, recording media 13 on which the program is recorded may be distributed. Alternatively, the program may be stored in a server computer and may be transferred to the computer through a network. The computer stores the program recorded on the recording medium 13 or transferred over the network, for example, in a local non-volatile storage device. Then, the computer reads the program from the non-volatile storage device and runs the program. Alternatively, the computer may sequentially load the obtained program to a RAM and run the program, without storing the program in the non-volatile storage medium.

According to one aspect, it is possible to speed up the shutdown processes of virtual machines with high priority level.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus on which a plurality of virtual machines is able to run, the information processing apparatus comprising:
a memory configured to store information indicating a priority level of each of the plurality of virtual machines; and
a processor configured to perform a process including:
selecting, when causing the plurality of virtual machines to perform shutdown processes in parallel, a first virtual machine from the plurality of virtual machines with reference to the memory,
selecting one or more second virtual machines from virtual machines with lower priority level than the first virtual machine with reference to the memory,
reducing an amount of resources allocated to the selected one or more second virtual machines, and
increasing an amount of resources allocated to the first virtual machine using resources equivalent to the reduced amount of resources.

2. The information processing apparatus according to claim 1, wherein:
the memory further stores information indicating whether each of the plurality of virtual machines is a candidate for safe shutdown or not; and
the selecting one or more second virtual machines includes selecting the one or more second virtual machines from virtual machines that are not candidates for safe shutdown with reference to the memory.

3. The information processing apparatus according to claim 2, wherein the selecting one or more second virtual machines includes selecting, as second virtual machines, virtual machines each having a current amount of resources allocated greater than a predetermined allocated resource amount from the virtual machines that are not candidates for safe shutdown, and reducing an amount of resources allocated to each of the second virtual machines by a differential amount between the predetermined allocated resource amount and the current amount of resources allocated.

4. The information processing apparatus according to claim 3, wherein, when the amount of resources allocated to the first virtual machine does not reach a threshold after an amount of resources reduced from the second virtual machines selected from the virtual machines that are not candidates for safe shutdown is added to the first virtual machine, the process further includes selecting second virtual machines from virtual machines that are candidates for safe shutdown.

5. The information processing apparatus according to claim 4, wherein the selecting second virtual machines from virtual machines that are candidates for safe shutdown includes sequentially selecting, as the second virtual machines, virtual machines in order from a lowest priority level from the virtual machines that are candidates for safe shutdown until the amount of resources allocated to the first virtual machine reaches the threshold.

6. The information processing apparatus according to claim 1, wherein, when any of the plurality of virtual machines completes shutdown, the process further includes newly selecting the first virtual machine from virtual machines performing shutdown processes with reference to the memory, and increasing an amount of resources allocated to the newly selected first virtual machine using resources allocated to the virtual machine that has completed shutdown.

7. The information processing apparatus according to claim 1, wherein the selecting a first virtual machine includes selecting, as the first virtual machine, a virtual machine with highest priority level from running virtual machines.

8. The information processing apparatus according to claim 1, wherein the process further includes, when first selecting the first virtual machine, changing amounts of resources respectively allocated to the plurality of virtual machines to a same amount of resources.

9. The information processing apparatus according to claim 1, wherein:
a control virtual machine for controlling the plurality of virtual machines runs on the information processing apparatus; and
the process further includes, after all of the plurality of virtual machines complete shutdown, allocating the control virtual machine all resources allocated to the plurality of virtual machines to cause the control virtual machine to perform a shutdown process.

10. The information processing apparatus according to claim 1, wherein, when a first time has elapsed after issuance of an instruction for shutdown to the plurality of virtual machines, the process further includes forcibly shutting down virtual machines performing the shutdown processes.

11. The information processing apparatus according to claim 10, wherein the process further includes determining the first time based on a second time during which power supply from a device used in a power source of the information processing apparatus is available.

12. A virtual machine shutdown method executed by an information processing apparatus on which a plurality of virtual machines is able to run, the method comprising:
when causing the plurality of virtual machines to perform shutdown processes in parallel,
increasing, by a processor, an amount of resources of the information processing apparatus allocated to a first virtual machine with relatively high priority level, among the plurality of virtual machines, and
reducing, by the processor, an amount of resources of the information processing apparatus allocated to a second virtual machine with relatively low priority level, among the plurality of virtual machines.

13. A non-transitory computer-readable storage medium storing a computer program that causes a computer on which a plurality of virtual machines is able to run to perform a process comprising:
selecting, when causing the plurality of virtual machines to perform shutdown processes in parallel, a first virtual machine from the plurality of virtual machines with reference to information indicating a priority level of each of the plurality of virtual machines, and selecting one or more second virtual machines from virtual machines with lower priority level than the first virtual machine with reference to the information; and
reducing an amount of resources allocated to the selected one or more second virtual machines, and increasing an amount of resources allocated to the first virtual machine using resources equivalent to the reduced amount of resources.
